(19) United States
(12) Patent Application Publication
(10) Pub. No.: US 2025/0381680 A1
(43) Pub. Date: Dec. 18, 2025

(54) Magnetic grippers, system consisting of a magnetic gripper receiving device and magnetic grippers, handling device and method for gripping

(71) Applicant: SCHUNK SE & Co. KG Spanntechnik Greiftechnik Automatisierungstechnik, Lauffen am Neckar (DE)

(72) Inventors: Wilhelm Ganslmeier-Janisch, München (DE); Marcel Conz, Güglingen (DE); Frank Clemens Schnittker, Damme (DE); Thomas Ruoff, Ötisheim-Schönenberg (DE)

(21) Appl. No.: 18/877,669

(22) PCT Filed: Jun. 26, 2023
(86) PCT No.: PCT/EP2023/067230

§ 371 Date: Dec. 20, 2024

(30) Foreign Application Priority Data
Jun. 24, 2022 (DE) 10 2022 115 855.1
Dec. 30, 2022 (DE) 10 2022 135 066.5

(51) Int. Cl. B25J 15/06

(52) U.S. Cl. CPC B25J 15/0608

(57) ABSTRACT

A magnetic gripper for a handling device for gripping a magnetizable and/or magnetic workpiece includes a gripper base portion with an interior space, a piston portion with a piston rod extending along a longitudinal axis with a piston at the piston rod and in the interior space, a magnetic portion with a holding magnet. The magnetic portion is displaceable with the piston portion along the longitudinal axis between upper release and lower contact positions. A stripping portion with a stripper is at the piston rod and/or at the gripper base portion for releasing a gripping connection between the magnetic portion and the workpiece when the magnetic portion is displaced. The gripper base and/or piston portions are designed so the magnetic portion, in the contact position, protrudes along the longitudinal axis relative to the stripping portion. The magnetic portion has a magnet holder for receiving the holding magnet.

The invention relates to a magnetic gripper, a system with magnetic grippers, a handling device, and a method for simultaneously gripping workpieces with a height offset.

Electric vehicles with a battery storage system comprise a large number of battery cells to provide the electrical energy for moving the electric vehicle. The large number of battery cells are often received in a battery cell housing. The battery cells can have different shapes. For example, cylindrical battery cells, prismatic battery cells or pouch battery cells are used for a battery storage system of an electric vehicle. The battery cells can also vary within the individual shapes, for example in their size.

Manually arranging the individual battery cells of the large number of battery cells in the battery cell housing is time-consuming and not cost-efficient. Furthermore, handling devices with a mechanical gripper can often only grip a particular shape and/or size of battery cell, so that when there is a change of a battery cell shape or size, complicated conversion work on the handling device may be necessary.

The invention is based on the object of providing a magnetic gripper for a handling device, or a system comprising a plurality of magnetic grippers and a magnetic gripper receiving device, or a handling device, with which a particularly simple and/or efficient and/or fast and/or safe handling of magnetic and/or magnetizable workpieces is possible, in particular to provide a repeatable, safe gripping of workpieces with differing heights, preferably a repeatable, safe and simultaneous gripping of a large number of workpieces with differing heights.

This object is achieved by a magnetic gripper having the features of claim 1. The magnetic gripper is intended for arrangement on a handling device and/or on a manipulator, such as a robot or gantry system. The magnetic gripper is designed to grip at least partially magnetizable and/or magnetic, in particular ferromagnetic, workpieces. The magnetic gripper has a gripper base portion with an interior, wherein the interior space is preferably cylindrical and/or formed with an upper cylinder end and a lower cylinder end. Furthermore, the magnetic gripper provides a piston portion with a piston rod extending along a longitudinal axis and with a piston arranged at the piston rod and in the interior space of the gripper base portion.

In addition, the magnetic gripper provides a magnetic portion with holding magnets for magnetically gripping the workpiece. The holding magnets each have a magnetic north pole and a magnetic south pole. The magnetic portion is arranged at the piston rod and/or on the gripper base portion. The piston rod and/or the magnetic portion can be displaced by means of the piston along the longitudinal axis between an upper release position and a lower contact position. The stroke of the piston portion preferably corresponds substantially to the distance between the upper cylinder end and the lower cylinder end. The upper release position of the magnetic portion preferably corresponds to the piston position at the upper cylinder end, and the lower contact position of the magnetic portion corresponds to the piston position at the lower cylinder end.

When gripping, the magnetic portion further comprises at least one first holding magnet with a north pole facing the workpiece and at least one holding magnet with a south pole facing the workpiece. Accordingly, the south pole of the first holding magnet and the north pole of the second holding magnet face the piston and/or the upper cylinder end.

Such a magnetic gripper has the advantage that a workpiece, in particular a battery cell, can be gripped easily, efficiently, fast and/or safely, regardless of the actual height. The magnetic gripper can be displaced to a predetermined starting position by means of the handling device, wherein the workpiece to be gripped does not yet come into contact with the magnetic gripper, in particular with the gripper base portion and/or the stripping portion. The opposite orientation of the holding magnets creates a self-contained, axially directed magnetic field, which also allows workpieces that are at a distance from the magnetic portion to be gripped. Consequently, safe gripping of workpieces with different heights is ensured without the handling device having to move the magnetic gripper to different starting positions.

Advantageously, the magnetic gripper further comprises a stripping portion with at least one stripper for releasing a magnetic gripping connection between the magnetic portion and the workpiece, wherein the stripping portion is arranged at the piston rod and/or on the gripper base portion and is designed to strip the workpiece gripped by the magnetic portion when the piston rod is displaced along the longitudinal axis of the piston rod by means of the at least one stripper. It is conceivable that, in addition to the stripping portion, a presser is also provided for pressing the workpieces onto the magnetic gripper. Alternatively, it is conceivable that the stripping portion comprises the presser. This has the advantage that the gripped workpiece can be easily and safely released from the magnetic portion by the stripping portion when the magnetic portion is displaced in the direction of the release position. The distance between the magnetic portion and the workpiece is increased by the stripping portion until the magnetic attraction force is no longer sufficient to maintain a magnetic gripping connection between the holding magnet and the workpiece.

An advantageous development of the invention provides that the at least one first holding magnet is arranged along a first circular line arranged around the longitudinal axis with a first diameter, and/or wherein the at least one second holding magnet is arranged along a second circular line arranged around the longitudinal axis with a second diameter. The annular arrangement of the individual first holding magnets and/or the individual second holding magnets results in a magnetic field with an improved axial orientation.

It is advantageous that the first diameter is greater than the second diameter. Alternatively, it is conceivable that the second diameter is greater than the first diameter. Furthermore, it is advantageous if the ratio between the first diameter and the second diameter is greater than 0.2:1, in particular greater than 0.5:1, preferably greater than 1:1 and preferably greater than 1.2:1 and/or less than 5:1, in particular less than 3:1, preferably less than 2:1 and preferably less than 1.5:1.

Advantageously, the magnetic portion has at least two first holding magnets, wherein in particular two first holding magnets that are adjacent along the circumference of the first circular line enclose a first angle α with the longitudinal axis. The first angle α is determined according to the following equation:

α=360°/n_{number of first holding magnets}

For the case of six first holding magnets, two adjacent first holding magnets have a first angle α of 60°.

Advantageously, the magnetic portion has at least two second holding magnets, wherein in particular two second holding magnets that are adjacent along the circumference of the second circular line enclose a second angle β with the longitudinal axis. The second angle β is determined according to the following equation:

β=360°/n_{number of second holding magnets}

For the case of six second holding magnets, two adjacent second holding magnets have a first angle α of 60°.

For the case of six first holding magnets and six second holding magnets, two adjacent holding magnets, i.e., a first holding magnet and a second holding magnet, have an angle γ of 30°. Accordingly, a uniformly distributed, axially directed magnetic field can be provided. To provide an axially directed magnetic field, it is advantageous if an even number (divisible by 2 without a remainder) of holding magnets is provided.

The underlying object of the invention is further achieved by a magnetic gripper having the features of claim 6. The magnetic gripper is provided for arrangement on a handling device and/or manipulator, such as a robot or gantry system. The magnetic gripper is designed to grip at least partially magnetizable and/or magnetic, in particular ferromagnetic, workpieces. The magnetic gripper has a gripper base portion with an interior space, wherein the interior is preferably cylindrical and/or formed with an upper cylinder end and a lower cylinder end. Furthermore, the magnetic gripper provides a piston portion with a piston rod extending along a longitudinal axis and with a piston arranged at the piston rod and in the interior space of the gripper base portion.

In addition, the magnetic gripper provides a magnetic portion with at least one holding magnet for magnetically gripping the workpiece, wherein the magnetic portion is arranged at the piston rod and/or on the gripper base portion.

The holding magnets can be permanent magnets, in particular permanent neodymium magnets.

The piston rod and/or the magnetic portion can be displaced by means of the piston along the longitudinal axis between an upper release position and a lower contact position. The maximum stroke of the piston portion preferably corresponds substantially to the distance between the upper cylinder end and the lower cylinder end. The upper release position of the magnetic portion preferably corresponds to the piston position at the upper cylinder end, and the lower contact position of the magnetic portion corresponds to the piston position at the lower cylinder end.

Furthermore, the magnetic gripper comprises a stripping portion with at least one stripper for releasing a magnetic gripping connection between the magnetic portion and the workpiece, wherein the stripping portion is arranged at the piston rod and/or on the gripper base portion and is designed to use the at least one stripper to strip the workpiece gripped by the magnetic portion when the piston rod is displaced along the longitudinal axis of the piston rod. It is conceivable that, in addition to the stripping portion, a presser is also provided for pressing the workpieces onto the magnetic gripper. Alternatively, it is conceivable that the stripping portion comprises a presser.

Such a magnetic gripper has the advantage that a workpiece can be handled particularly easily and/or efficiently and/or fast and/or safely.

By displacing the piston rod along the longitudinal axis of the piston rod in interaction with the stripping portion of the magnetic gripper, a distance between the magnetic portion, or the at least one holding magnet of the magnetic portion, and the gripped workpiece can be increased such that a magnetic attraction force between the magnetic portion, or the at least one holding magnet of the magnetic portion, and the workpiece is reduced until the magnetic gripping connection between the magnetic portion and the workpiece is released. By displacing the piston rod along the longitudinal axis of the piston rod, a magnetizable and/or magnetic workpiece, e.g., a battery cell of a battery system, can be particularly easily released or stripped off.

An advantageous further development provides that the stripping portion has a plurality of strippers. The plurality of strippers can be arranged radially offset from one another around the longitudinal axis of the piston rod. Due to the plurality of strippers, the workpiece gripped by the magnetic portion can be stripped or released from the magnetic portion particularly evenly and safely when the piston rod is displaced along the longitudinal axis of the piston rod. Furthermore, the plurality of strippers can extend in a direction parallel to the longitudinal axis of the piston rod in the direction of the gripped workpiece. In addition, the plurality of strippers can be designed in the shape of a pin, for example. The plurality of strippers can be, for example, two, three or four strippers. For example, four strippers can be arranged offset by 90° from each other with respect to the longitudinal axis of the piston rod. Furthermore, different geometric shapes can be safely stripped using a plurality of strippers, since the gripped workpiece does not have to be made complementary to the overall shape of the single stripper, but only in the region of the plurality of strippers in each case. Furthermore, the provision of a plurality of strippers results in an easier customizability of the easy customizability formed by the stripper surface. In addition, the plurality of strippers is easier to manufacture and easier to replace.

Furthermore, the gripper base portion and/or the piston portion and/or the magnetic portion and/or the stripping portion are preferably designed such that the magnetic portion, in the contact position, protrudes along the longitudinal axis relative to the stripping portion. In the release position, the gripper base portion and/or the stripping portion preferably receive the magnetic portion, in particular completely.

Such a magnetic gripper has the advantage that a workpiece, in particular a battery cell, can be gripped easily, efficiently, fast and/or safely, regardless of the actual height. The magnetic gripper can be displaced to a predetermined starting position by means of the handling device, wherein the workpiece to be gripped does not yet come into contact with the magnetic gripper, in particular with the gripper base portion and/or the stripping portion. To compensate for the height offset of the workpiece or the distance between the magnetic portion and the workpiece, the magnetic portion is displaced into the lower contact position. Consequently, safe gripping of workpieces with different heights is ensured without the handling device having to move the magnetic gripper to different starting positions. Furthermore, the magnetic gripper is designed in such a way that if the magnetic gripper is in contact with the workpiece already in the starting position, the workpiece is not pushed away or displaced when the magnetic portion is shifted.

Furthermore, such a magnetic gripper has the advantage that the gripped workpiece can be easily and safely released from the magnetic portion by the stripping portion when the magnetic portion is displaced in the direction of the release position. The distance between the magnetic portion and the workpiece is increased by the stripping portion until the magnetic attraction force is no longer sufficient to maintain a magnetic gripping connection between the holding magnet and the workpiece.

It is conceivable that the magnetic portion with the at least one holding magnet is arranged at the piston rod, and wherein the stripping portion with the at least one stripper is arranged at the gripper base portion. In this case, the distance between the magnetic portion, or the holding magnet, of the magnetic portion and the gripped workpiece can be increased by displacing the magnetic portion with the holding magnet away from the workpiece by displacing the piston rod along the longitudinal axis of the piston rod, wherein the stripper prevents the workpiece from moving along with the magnetic portion, or holding magnet, that is moving away. Alternatively, it is also conceivable that the magnetic portion with the at least one holding magnet is arranged at the gripper base portion, and wherein the stripping portion is arranged at the piston rod, wherein in particular the stripping portion is formed by a piston rod end of the piston rod. Here, the distance between the magnetic portion or the holding magnet of the magnetic portion and the gripped workpiece can be increased in that through a displacement of the piston rod along the longitudinal axis of the piston rod, the workpiece is actively moved or (actively) pushed away from the magnetic portion arranged at the gripper base portion, or the holding magnet of the magnetic portion, by the stripping portion arranged at the piston rod, or the stripper of the stripping portion.

The stripping of the workpiece gripped by the magnetic portion when the piston rod is displaced along the longitudinal axis of the piston rod by means of the at least one stripper can also be understood as a release of the magnetic gripping connection between the magnetic portion and the workpiece.

Because the gripper base portion has an interior space and the piston portion with the piston and the piston rod is arranged in the interior space, the piston rod can also easily be displaced along the longitudinal axis of the piston rod by displacing the piston. In particular, the piston fluidically separates the interior space of the gripper base portion into a first active chamber and a second active chamber. The first active chamber can be pressurizable with a pressure medium, e.g., pressurized air, and/or the second active chamber can be pressurizable with a pressure medium, e.g., pressurized air, in order to axially displace the piston and thus the piston rod along the longitudinal axis of the piston rod. In particular, the gripper base portion can be designed to be double-acting with the piston portion. It is also conceivable for only the first active chamber to have a spring element, e.g., a coil spring, and for (only) the second active chamber to be pressurizable with a pressure medium, e.g., pressurized air, or vice versa. In this way, the magnetic gripper can be particularly simple and cost-effective in its construction. In other words, the gripper base portion with the piston portion can also be designed to be single-acting.

The gripper base portion is in particular made of a non-magnetic and/or non-magnetizable material. The gripper base portion can, for example, comprise aluminum or be made of aluminum. Preferably, the piston and/or the piston rod of the piston portion are also made of a non-magnetic and/or non-magnetizable material. Furthermore, the gripper base portion and/or the interior space of the gripper base portion can be cylindrical. This means that the gripper base portion can be particularly compact. Furthermore, a plurality of magnetic grippers can be accommodated next to one another in a particularly space-saving manner by a magnetic gripper receiving device, as described in particular below. This means that even a high packing density, such as that found in a battery storage system, can be accommodated. Furthermore, the gripper base portion can have a bottom side facing the handling device or facing away from the gripped workpiece, as well as a gripping side opposite the bottom side and facing the gripped workpiece. Furthermore, the gripper base portion can have a recess, in particular on a (gripping) side of the gripper base portion facing the gripped workpiece, for a supported guidance of the piston rod. In this way, at least part of the piston rod can extend out from the gripper base portion. Advantageously, the magnetic portion can be arranged at the part of the piston rod that extends out, in particular on one piston rod end of the piston rod. Alternatively, the stripping portion can also be arranged at the part of the piston rod that extends out, in particular on one end of the piston rod. Furthermore, the gripper base portion can have a fastening interface for fastening the magnetic portion and/or the stripping portion.

Furthermore, the gripper base portion, in particular in a region facing away from the gripped workpiece, can have a mounting portion for arrangement on a tool receptacle and/or on a tool holder and/or on a receiving portion of a magnetic gripper receiving device of the handling device.

The magnetic portion with the at least one holding magnet is arranged in particular on the piston rod or the gripper base portion in such a way that it faces the gripped workpiece. Furthermore, the magnetic portion or the at least one holding magnet can be arranged in a materially bonded manner, for example glued, on the piston rod or the gripper base portion. It can further be provided that the magnetic portion has a plurality of individual holding magnets for magnetically gripping the workpiece. This allows the workpiece to be gripped particularly evenly. The plurality of holding magnets can in particular be arranged radially offset from one another around the longitudinal axis of the piston rod. Thus, a magnetic gripping connection between the magnetic portion and the workpiece can be particularly uniform.

The stripping portion with the at least one stripper is also arranged at the piston rod or the gripper base portion in such a way that it faces the gripped workpiece.

Furthermore, the stripping portion or the stripper can be arranged at the gripper base portion by means of one or more screw connections. The at least one screw connection or the plurality of screw connections extends/extend in particular parallel to the longitudinal axis of the piston rod in a wall of the gripper base portion and in the stripping portion or stripper. In this way, interfering contours on an outer surface of the gripper base portion can be prevented. A thread can be formed in the stripping portion or stripper to form a screw connection.

The magnetic gripper in particular has a gripping state in which the magnetic portion is in magnetic gripping connection with the workpiece. In the magnetic gripping connection, in particular the workpiece is magnetically held to the magnetic gripper by the at least one holding magnet. In a release state of the magnetic gripper, the magnetic gripping connection between the magnetic portion and the workpiece is released. In other words, the workpiece is so far away from the magnetic portion, or the holding magnet of the magnetic portion, that the attractive force of the holding magnet is too low to grip the workpiece.

A preferred embodiment results from the fact that the piston portion and/or the magnetic portion and/or the stripping portion has a damping element for a damping gripping of the workpiece.

Thus, when the magnetic gripper is placed on the workpiece to grip the workpiece, a compensating movement can be carried out by the damping element to grip the workpiece and the gripping can be carried out particularly safely and gently. The magnetic portion can include the damping element. Alternatively or additionally, the stripping portion and/or the piston portion can also have the damping element. The damping element can be, for example, a spring element arranged in a first active chamber or second active chamber, for example a coil spring. Alternatively or additionally, it is also conceivable for the damping element to be a damping polymer, e.g., an elastomer. The damping element, in particular the damping polymer, can further form a damping layer. This means that the damping element can be designed particularly simply. It is also conceivable that the magnetic gripper has a plurality of damping elements for a damping gripping of the workpiece. In other words, the piston portion can have a (first) damping element and/or the magnetic portion can have a (second) damping element and/or the stripping portion can have a (third) damping element for a damping gripping of the workpiece. This allows the workpiece to be gripped particularly gently. For example, the piston portion can have a spring element arranged in a first active chamber or second active chamber, for example a coil spring, as the first damping element and the magnetic portion can have a second damping element, for example a damping layer, and/or the stripping portion can have a third damping element, for example a further damping layer.

In a further embodiment, the magnetic portion and/or the stripping portion has a centering element for centered gripping of the workpiece. This ensures that the workpiece is held or gripped safely. The magnetic portion can include the centering element. Alternatively or additionally, the stripping portion can also have the centering element. The centering element is designed for the centered gripping of the workpiece, in particular corresponding to a characteristic point on the workpiece to be gripped. For example, in a battery cell with a cylindrical positive pole, the centering element can have a correspondingly shaped recess. In particular, however, it is also conceivable for the centering element to have a centering edge for the centered gripping of the workpiece. As a result, the centering element can be designed particularly simply. Advantageously, the at least one stripper of the stripper element can additionally or simultaneously form the centering element, for example in that the stripper has a centering edge.

As a further advantageous embodiment of the invention, it is provided that the magnetic portion and/or the stripping portion has a friction element for frictionally contacting the workpiece. Thus, at least part of the force for holding the gripped workpiece can be provided by an adhesive force formed between the workpiece and the friction element, and the at least one holding magnet of the magnetic portion can be made small (er) or magnetically weak (er). The magnetic portion can include the friction element for frictionally contacting the workpiece. Alternatively or additionally, the stripping portion can also have the friction element. The friction element can be a friction ring or a friction-increasing layer, in particular a friction-increasing coating. For example, the friction element can be made of glass-fiber-reinforced plastics material. In particular, the friction element is non-magnetic and/or non-magnetizable. Advantageously, the at least one stripper of the stripper element can additionally or simultaneously form the friction element, for example in that the stripper has a friction-increasing layer and/or is formed from a friction-increasing material such as glass-fiber-reinforced plastics material.

It is also particularly preferred that the magnetic portion with the at least one holding magnet is designed such that the at least one holding magnet in the magnetic gripping connection with the workpiece has a predefined distance from the workpiece. In other words, the at least one holding magnet in the magnetic gripping connection with the workpiece contacts the workpiece (only) indirectly. This makes it particularly easy to release a magnetic gripping connection between the magnetic portion and the workpiece. Furthermore, damage to the workpiece by the holding magnet can be prevented. A particularly preferred embodiment results from the fact that the magnetic portion and/or the stripping portion has at least one non-magnetic and/or non-magnetizable separating element for forming the predefined distance between the at least one holding magnet in the magnetic gripping connection with the workpiece. In particular, the separating element is at least partially arranged between the at least one holding magnet of the magnetic portion and the gripped workpiece. The separating element can be a separating layer or a separating plate. For example, the separating layer or separating plate can contain aluminum or be made of aluminum. It is also conceivable for the separating element to additionally or simultaneously act as a friction element. Alternatively and/or additionally, at least the gripper base portion with the interior space, the piston portion with the piston and the piston rod, the magnetic portion and the stripping portion of the magnetic gripper can be designed or matched to one another in such a way that the holding magnet of the magnetic portion has or maintains the predefined distance from the gripped workpiece in a gripping state of the magnetic gripper.

In a further embodiment, the stripper of the stripping portion arranged at the piston rod is axially fixed in position in relation to the piston rod. In other words, when the piston rod is displaced along the longitudinal axis of the piston rod, the position of the stripper in relation to the piston rod remains the same. Thus, by displacing the piston rod along the longitudinal axis of the piston rod, the workpiece can be actively moved or (actively) pushed away from the magnetic portion arranged at the gripper base portion, or the holding magnet of the magnetic portion, by the stripping portion arranged at the piston rod, or the stripper of the stripping portion. Alternatively, the stripper of the stripping portion arranged at the gripper base portion is fixed in position axially along the longitudinal axis of the piston rod with respect to the gripper base portion. In other words, at least one stripper is a rigid stripper. Thus, when the magnetic gripping connection between the magnetic portion and the gripped workpiece is released, the workpiece can be prevented from displacing along with the magnetic portion or holding magnet, which is moving away due to the displacement of the piston rod.

In particular, it is advantageous if the stripper of the stripping portion arranged at the gripper base portion has a stripper cavity for guiding the magnetic portion arranged at the piston rod in the stripper cavity along the longitudinal axis of the piston rod, wherein the stripper has a stop at one stripper end for striking the workpiece, in particular at least when releasing the magnetic gripping connection. In this way, the magnetic gripper can be designed particularly simply. The stripper can, for example, be designed in the shape of a sleeve or as a hollow cylinder. Advantageously, the sleeve-shaped stripper can be arranged at a cylindrical gripper base portion, in particular on a gripping side of the gripper base portion. As a result, the magnetic gripper can be particularly compact. For example, the sleeve-shaped stripper can be arranged at the cylindrical gripper base portion by means of one or more screw connections. The at least one screw connection or the plurality of screw connections extends/extend in particular at least partially parallel to the longitudinal axis of the piston rod in a cylinder wall of the cylindrical gripper base portion. In this way, interfering contours on an outer surface of the gripper base portion can be prevented. A thread can be formed in the stripping portion or stripper for forming a screw connection. Advantageously, the stripper with the stripper cavity for guiding the magnetic portion arranged at the piston rod further comprises aluminum or is made of aluminum. In particular, the stripper with the stripper cavity for guiding the magnetic portion arranged at the piston rod is a turned part made of aluminum. This makes it particularly easy to manufacture the stripping portion or stripper. An edge of the stripper facing the gripped workpiece can form the stop for striking the workpiece during the magnetic gripping and/or magnetic release of the workpiece. In particular, the stop serves to ensure that the magnetic gripping connection between the magnetic portion and the gripped workpiece can be released when the piston rod is displaced along the longitudinal axis of the piston rod. In addition, a non-magnetic and/or non-magnetizable separating element, e.g., a non-magnetic and/or non-magnetizable separating plate, can be arranged at the edge of the stripper to simplify the release of the gripping connection.

As a further advantageous embodiment of the invention, it is provided that the stripper of the stripping portion arranged at the piston rod is a piston rod end of the piston rod. This means that the magnetic gripper can be particularly simple and cost-effective in its design. The piston rod end of the piston rod that forms the stripper is in particular the piston rod end that faces the gripped workpiece. By displacing the piston rod along the longitudinal axis of the piston rod, the gripped workpiece can be actively moved or (actively) pushed away by the end of the piston rod away from the magnetic portion arranged at the gripper base portion, or the holding magnet of the magnetic portion, and thus the magnetic gripping connection between the magnetic portion and the workpiece can be released or stripped.

It is also particularly preferred that the gripper base portion has at least one pressure medium inlet on a bottom side of the gripper base portion facing away from the gripped workpiece for supplying the piston arranged in the interior space with a pressure medium for displacing the piston along the longitudinal axis of the piston rod, wherein in particular the gripper base portion is designed to be flat or substantially flat on the bottom side. In this way, disruptive pressure medium hoses on an outer surface of the gripper base portion can be avoided and a plurality of magnetic grippers can be received in a particularly space-saving manner by a magnetic gripper receiving device. The pressure medium inlet can further comprise at least one pressure medium channel formed in a wall of the gripper base portion for a fluidic connection to a first active chamber or a second active chamber of the gripper base portion. The wall of the gripper base portion is in particular the part of the gripper base portion which connects a gripping side of the gripper base portion facing the gripped workpiece and a bottom side of the gripper base portion facing away from the gripped workpiece, wherein in particular the gripping side and the bottom side are situated opposite one another. If the gripper base portion is designed to be double-acting with the piston portion, then the gripper base portion advantageously has a first pressure medium inlet and a second pressure medium inlet on the bottom side of the gripper base portion facing away from the gripped workpiece in order to supply the piston arranged in the interior space with, in each case, a pressure medium for displacing the piston along the longitudinal axis of the piston rod. The second pressure medium inlet can also further comprise at least one pressure medium channel formed in the wall of the gripper base portion for a fluidic connection to a first active chamber or a second active chamber of the gripper base portion.

Furthermore, it is advantageous if the gripper base portion and/or the magnetic portion and/or the stripping portion has a magnet holder for receiving the holding magnets. In addition, it is advantageous if an insulating element is arranged between the magnet holder and the piston portion, wherein the insulating element promotes an orientation of the magnetic field in the direction of the workpiece. The insulating element can comprise at least one of the following elements: Al, Zn, Mg, Cu, and/or can preferably be formed from an aluminum-zinc basis.

In addition, the magnet holder can have a holding leg that radially surrounds the at least one holding magnet, in particular completely, and/or is cylindrical. The holding leg also orients the magnetic field in the direction of the workpiece and also ensures radial protection of the magnetic field. Accordingly, when using a plurality of magnetic grippers arranged radially next to one another, there is little or no mutual influence of the magnetic fields, in particular no magnetic field attenuation. The magnet holder, in particular the holding leg, preferably comprises a magnetic, in particular ferromagnetic, and/or metallic material.

The magnet receptacle advantageously has magnet receptacles which ensure an exact positioning, in particular exact height positioning, of the holding magnets. The magnet receptacles have at least partially the cross section of the holding magnets and/or act to guide and hold the holding magnets. The exact positioning of the holding magnets in the magnet holder ensures an optimal axial orientation of the magnetic field. It is advantageous if the empty space of the magnet holder is filled with a material that does not influence the magnetic field, in particular epoxy resin, preferably by pouring. The side of the magnet holder facing the workpiece is then milled or turned so that each holding magnet and/or each magnetic gripper has a defined magnetic portion end. Thus, a defined air gap can be created between the holding magnets and the workpiece by positioning the magnetic gripper and/or the magnetic portion. Consequently, a targeted gripping force and/or magnetic force adjustment is possible.

It is advantageous if the piston delimits, with the interior space, an upper first pressure chamber above the piston and a lower second pressure chamber below the piston. In order to displace the piston and/or the magnetic portion from the release position to the contact position, or to the workpiece, the first pressure chamber can preferably be subjected to a first operating pressure. In order to displace the piston and/or the magnetic portion from the contact position to the release position, or away from the workpiece, the second pressure chamber can be subjected to a second operating pressure. Consequently, a precise displacement of the magnetic portion can be achieved by a pneumatic or hydraulic drive.

A particularly preferred embodiment results from the fact that the magnetic gripper has a state sensor at least for detecting a gripping state of the magnetic gripper, in which the magnetic portion is in the magnetic gripping connection with the workpiece, and for detecting a release state of the magnetic gripper, in which the magnetic gripping connection between the magnetic portion and the workpiece is released. In this way, process safety can be achieved. Preferably, a single state sensor detects both the gripping state and the release state. The state sensor can, for example, be a magnetic switch. The state sensor can also be arranged at an outer surface of the gripper base portion. In particular, the detection of the gripping state of the magnetic gripper and the detection of the release state of the magnetic gripper can be carried out by detecting the axial position of the piston in the interior space of the gripper base portion. This makes it particularly easy to detect the gripping or release state. Furthermore, in particular in the gripping state of the magnetic gripper, the piston of the piston portion is in a piston gripping position, and in the release state of the magnetic gripper the piston of the piston portion is in a piston release position.

The object of the invention is also achieved by a system having the features of claim 13. This system for a handling device comprises a magnetic gripper receiving device with a receiving portion for receiving magnetic grippers.

Furthermore, the system provides a plurality of magnetic grippers, wherein in particular each of the magnetic grippers of the plurality of magnetic grippers is designed according to the invention. Furthermore, the system provides that the magnetic grippers of the plurality of magnetic grippers is received in the receiving portion of the magnetic gripper receiving device.

Because the magnetic gripper receiving device accommodates a plurality of magnetic grippers, a handling device operatively connected to the magnetic gripper receiving device can handle a plurality of workpieces simultaneously by means of the plurality of magnetic grippers received in the magnetic gripper receiving device. Thus, the handling of a plurality of workpieces that are at least partially magnetic and/or at least partially magnetizable can be carried out particularly fast, easily and efficiently. For example, a large number of battery cells can be arranged particularly fast, easily and efficiently in a battery cell housing of a battery storage system of an electric vehicle.

The plurality of magnetic grippers can also be understood as a large number of magnetic grippers.

This system for a handling device is preferably used for gripping at least partially magnetizable and/or magnetic workpieces, in particular for simultaneously gripping a plurality of workpieces, wherein the workpieces have a height offset from one another, e.g., due to manufacturing tolerances. The system comprises at least two magnetic grippers as described above and a receiving device for receiving the magnetic grippers.

The system confers the advantage that when the handling device approaches workpieces that have a height offset from one another, a distance can remain between the magnetic grippers and the workpieces. Through the displacement of the magnetic portion, in particular beyond the stripping portion, and/or through the axially oriented magnetic field of the holding magnets, the workpieces can be magnetically gripped, preferably pressed against the stripping portion, and then handled with the handling device. Due to the magnetic grippers arranged radially next to one another, magnetic field losses can occur, which can be prevented either by lower magnetic fields with a displacement of the magnetic portion or by directed magnetic fields. The system according to the invention is particularly advantageous for magnetic grippers arranged radially next to one another.

Furthermore, the magnetic gripper receiving device of the system can have a handling mounting portion for arrangement on a tool receptacle and/or a tool receptacle and/or a machine spindle of the handling device.

The plurality of magnetic grippers is received in each case in the receiving portion of the magnetic gripper receiving device with a non-positive fit and/or with a positive fit, and in particular in addition releasably. This makes it particularly easy to replace defective magnetic grippers.

In particular, it is advantageous if the receiving portion is designed such that the magnetic grippers of the plurality of magnetic grippers are received at least in one row next to one another in the receiving portion. In other words, the magnetic grippers can be received in a row next to one another in the receiving portion. This means that a high packing density, such as that found in a battery storage system, can be accommodated. It is also conceivable that the plurality of magnetic grippers is received both in a row and in a column in the receiving portion. This allows for two-dimensional gripping or handling of at least partially magnetizable and/or magnetic workpieces. This means that multiple workpieces can be handled particularly fast, easily and efficiently.

It is also particularly preferred that the magnetic gripper receiving device has at least one pressure medium distribution channel for fluidically supplying each of the plurality of magnetic grippers with a pressure medium for displacing a corresponding piston of the magnetic grippers. In this way, the plurality of magnetic grippers can be fluidically supplied with a pressure medium directly via the pressure medium distribution channel. Furthermore, disruptive pressure medium hoses on an outer surface of the gripper base portion of a magnetic gripper can be avoided, and the plurality of magnetic grippers can be received in a particularly space-saving manner by a magnetic gripper receiving device. For this purpose, a gripper base portion of each magnetic gripper can have at least one pressure medium inlet on a bottom side of the gripper base portion facing away from the gripped workpiece. The receiving portion and/or the pressure medium distribution channel of the magnetic gripper receiving device can have a pressure medium interface, correspondingly designed in each case, for the fluidic connection to the at least one pressure medium inlet of each magnetic gripper of the plurality of magnetic grippers. The fluidic connection of each magnetic gripper with the pressure medium distribution channel is thus advantageously done without tubes. It is also conceivable that the magnetic gripper receiving device has at least two pressure medium distribution channels for distributing a first pressure medium and a second pressure medium to the plurality of magnetic grippers. Thus, double-acting magnetic grippers or double-acting piston portions of the plurality of magnetic grippers can also be operated by means of the magnetic gripper receiving device.

In a particularly preferred embodiment, the magnetic gripper receiving device has a state portion with a plurality of state sensors for detecting a gripping state of a magnetic gripper of each of the plurality of magnetic grippers, in which state the magnetic portion is in the magnetic gripping connection with the workpiece, and for detecting a release state of the corresponding magnetic gripper, in which the magnetic gripping connection between the magnetic portion and the workpiece is released. In this way, disruptive information lines for transmitting data and/or disruptive magnetic switches as state sensors on an outer surface of the gripper base portion of a magnetic gripper can be avoided, and a plurality of magnetic grippers can be received in a particularly space-saving manner by a magnetic gripper receiving device.

The receiving device can, in particular, be formed in the manner of a frame. Furthermore, the receiving device can be designed as a support structure or as a plurality of support structures, wherein a support structure comprises, for example, a number of 4, 8 or 15 magnetic grippers as a module. Accordingly, it is possible to assemble receiving devices of any size by assembling a plurality of support structures to form a large receiving device. The individual support structures are designed in such a way that they can be releasably connected to one another. The receiving device can also be provided with mounting portions for arranging handles or tool receptacles.

Furthermore, it is advantageous if the system is set up in such a way that, for the simultaneous gripping of workpieces with a height offset, a first magnetic portion is displaced into the contact position and at the same time a second magnetic portion is displaced into the gripping position. This can be achieved for example by using a pneumatic or hydraulic drive to displace the magnetic portions. The magnetic portions are displaced out of the release position until contact with the workpiece is made or the maximum stroke is reached. When displacing the magnetic portions, a third operating pressure is set so low that the magnetic portions are displaced but no damage is caused to the magnetic gripper or the workpiece, should the workpiece have a greater height than the other workpieces. The “soft” air cushion allows for gentle contact with the workpiece and at the same time prevents the workpiece from being pushed away. This means that there are no height differences between the magnetic gripper and the workpiece to be gripped due to the gripping process, which may not be able to be taken into account or compensated for by the magnetic gripper. Furthermore, the holding force of the axially amplified magnetic field may not be sufficient to attract the workpiece across the unintentionally created air gap. The air gap counteracts this disadvantage.

The object of the invention is also achieved by a handling device having the features of claim 16. This handling device is operatively connected to at least one magnetic gripper designed according to the invention. Alternatively, the handling device is operatively connected to at least one system designed according to the invention, in particular a magnetic gripper receiving device of a system designed according to the invention.

The handling device can be a robot, e.g., an industrial robot. Furthermore, the handling device, in particular a tool receptacle and/or a tool receptacle of the handling device, can have a counter-mounting portion for arranging on a mounting portion of a gripper base portion of the magnetic gripper for operatively connecting the handling device to the magnetic gripper. Alternatively or additionally, the handling device, in particular a tool receptacle and/or a tool receptacle of the handling device, can have a counter-handling mounting portion for arranging on a handling mounting portion of a magnetic gripper receiving device of the system for operatively connecting the handling device to the system according to the invention.

The invention also relates to a handling device with at least one magnetic gripper designed according to the invention. Alternatively, according to the invention, the handling device is provided with at least one system designed according to the invention. The handling device can be a robot, e.g., an industrial robot, or a linear axis system. Furthermore, the handling device, in particular a tool receptacle and/or a tool receptacle of the handling device, can have a counter-mounting portion for arranging on a mounting portion of a gripper base portion of the magnetic gripper for operatively connecting the handling device to the magnetic gripper. Alternatively or additionally, the handling device, in particular a tool receptacle and/or a tool receptacle of the handling device, can have a counter-handling mounting portion for arranging on a handling mounting portion of a receiving device of the system for operatively connecting the handling device to the system according to the invention.

The magnetic gripper according to any one of claims 1 to 12, the system according to claims 13 to 15, the handling device according to the invention and/or the method according to claim 17 or 18 can further comprise a controller. The control can be arranged in or on the magnetic gripper, in or on the system, and/or in or on the handling device. On the one hand, the controller can be used to detect operating states, in particular safe gripping of a workpiece and/or reaching the release position, contact position, gripping position, of the magnetic gripper or of each individual magnetic gripper in a system or in a handling device. It is also conceivable that a plurality of magnetic grippers is grouped in a system or in a handling device, wherein the operating states of the group of magnetic grippers can be detected as one state by means of the controller. The operating states can also be changed by means of the controller, e.g., by controlling a drive unit or valves. It can further be provided that the operating states that can be detected and/or changed by means of the controller can be displayed on a display unit, e.g., a display or illuminated displays. The display can be made on each magnetic gripper and/or on each group of magnetic grippers and/or on the system and/or on the handling device and/or the manipulator.

The underlying object of the invention is further achieved by a method having the features of claim 17. The method serves for gripping at least partially magnetizable and/or magnetic workpieces with a height offset from one another, wherein first workpieces have a first height and second workpieces have a second height, and wherein the first height is greater than the second height. The gripping can be carried out by means of a magnetic gripper with magnetic portions that can be displaced along a longitudinal axis between an upper release position and a lower contact position and stripping portions for releasing the magnetic connection between the magnetic portions and the workpieces. Alternatively, the gripping can be carried out by means of a magnetic gripper described above or by means of a system described above.

In the gripping according to the invention, the magnetic gripper is moved, for example by means of a handling device, into a starting position above the workpieces, wherein first magnetic grippers, in particular first stripping portions and/or first pressers, contact first workpieces (step a). Accordingly, some magnetic grippers are already in contact with the workpieces with the greatest height in the starting situation.

The magnetic portions are then applied to the workpieces by moving the magnetic portions (step b). On the workpieces that are already resting on the magnetic gripper in the starting situation, the magnetic portions are displaced to a gripping position arranged between the release position and the contact position. On the remaining workpieces, the magnetic portions are displaced into the contact position, wherein the magnetic portions come into contact with the workpieces. Accordingly, the first magnetic grippers rest with the first stripping portions and/or with the first pressers and with the first magnetic portions on the first workpieces, wherein the first workpieces have a greater height. Furthermore, the second magnetic grippers with the second magnetic portions rest on the second workpieces, wherein the second workpieces have a lower height. The maximum height offset between the first workpieces and the second workpieces substantially corresponds to the maximum stroke of the piston or of the magnetic portion.

The second workpieces are then lifted into the gripping position by displacing the second magnetic portions, wherein the second workpieces contact the second stripping portions and/or the second pressers (step c). By lifting the second magnetic portions, all magnetic portions are in the gripping position. Consequently, all workpieces have been brought to the stripping portions and/or to the presser. By attracting the workpieces, it is ensured that in a subsequent assembly, transport or handling process, the magnetic gripper is in uniform and flat contact with as many workpieces as possible and that no workpiece can fall out of or protrude from the workpiece assembly, in particular no battery can fall out of or protrude from the cell assembly of the battery cluster.

Consequently, the workpieces can be safely handled together (step d).

Finally, the workpieces are stripped from the magnetic grippers by displacing the magnetic portions to the release position, wherein the stripping portions release the magnetic connection between the magnetic portions and the workpieces (step e).

The method confers the advantage that the magnetic gripper can always be moved to the same starting situation and all workpieces can be safely gripped and subsequently handled despite height offsets.

The underlying object of the invention is further achieved by a method having the features of claim 18. The method serves for gripping at least partially magnetizable and/or magnetic workpieces with a height offset from one another, wherein first workpieces have a first height and second workpieces have a second height, and wherein the first height is greater than the second height. The gripping is carried out by means of a magnetic gripper with magnetic portions that can be displaced along a longitudinal axis between an upper release position and a lower contact position and stripping portions for releasing the magnetic connection between the magnetic portions and the workpieces. Alternatively, gripping is carried out by means of a magnetic gripper described above or by means of a system described above.

During gripping according to the invention, all magnetic portions of the magnetic grippers are displaced into the contact position protruding from the stripping portion and/or the presser (step a).

The magnetic gripper is then moved from above towards the workpieces, e.g., by means of a handling device, until the first magnetic portion contacts the first workpieces. The approach of the magnetic grippers is continued in this way until the first magnetic portions and the first stripping portions and/or the first pressers contact the first workpieces. Here the second magnetic portions also contact the second workpieces (step b).

In order to now also place the second workpieces on the second magnetic grippers for the purpose of a flat contact, the second magnetic portions are displaced from the contact position to the gripping position (step c). Accordingly, all workpieces have reached the stripping portions and/or the presser. By attracting the workpieces, it is ensured that in a subsequent assembly, transport or handling process, the magnetic gripper is in uniform and flat contact with all workpieces and that no workpiece can fall out of the workpiece assembly; in particular, no battery can protrude from the cell assembly of the battery cluster.

Consequently, the workpieces can be safely handled together (step d).

Finally, the workpieces are stripped from the magnetic grippers by displacing the magnetic portions to the release position, wherein the stripping portions release the magnetic connection between the magnetic portions and the workpieces (step e).

The method has the advantage that the workpieces can initially be approached gently, i.e., with little force or pressure, by means of the protruding magnetic portions. It is advantageous if the magnetic portions are driven pneumatically or hydraulically so that the magnetic portions are flexible. This results in a slight spring effect, which is particularly gentle on the workpieces to be gripped as well as on the gripper base portion and/or the receiving device of the magnetic gripper.

Alternatively, it is conceivable to arrange a compression spring in the first pressure chamber and/or a tension spring in the second pressure chamber on the piston. As the magnetic grippers move closer to the workpieces, the first magnetic grippers are pushed back by the workpieces from the contact position to the gripping position. In addition, the method also ensures safe gripping of workpieces with a height offset.

It is advantageous if, according to step a), in the starting position there is a first distance between the second magnetic portions and the second workpieces that is between 0 mm and 30 mm, in particular between 0 mm and 20 mm, preferably between 0 mm and 10 mm, further preferably between 0 mm and 5 mm and preferably between 0 mm and 2 mm.

Further details and advantageous embodiments of the invention can be found in the following description, by which exemplary embodiments of the invention are further described and explained.

In the drawings:

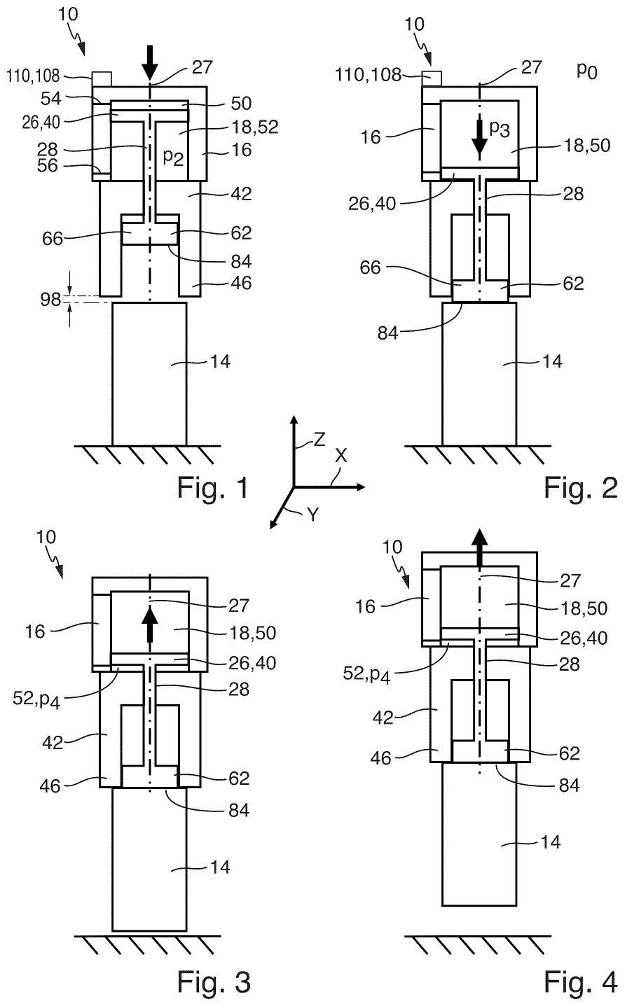

FIG. 1 is a schematic side view of a magnetic gripper according to the invention in a starting situation above the workpiece, with the magnetic portion in the release position,

FIG. 2 is a schematic side view of the magnetic gripper according to FIG. 1, wherein the magnetic portion is displaced into the contact position,

FIG. 3 is a schematic side view of the magnetic gripper according to FIG. 1, wherein the magnetic portion is displaced into the gripping position and the workpiece is slightly lifted,

FIG. 4 is a schematic side view of the magnetic gripper according to FIG. 1, wherein the magnetic gripper is displaced together with the workpiece,

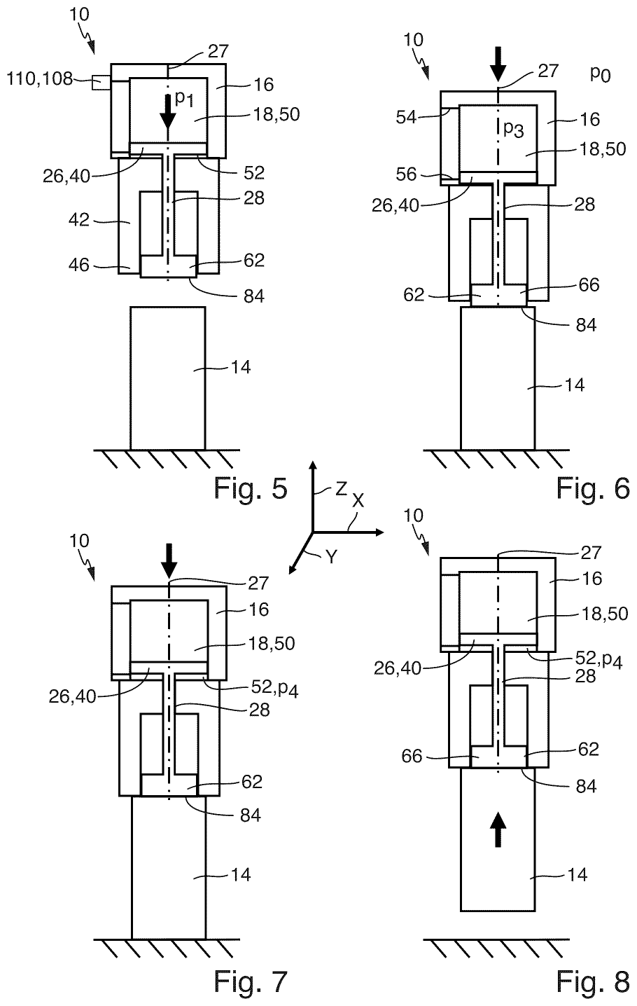

FIG. 5 is a schematic side view of a magnetic gripper according to the invention in a starting position above the workpiece, wherein the magnetic portion is displaced in the contact position,

FIG. 6 is a schematic side view of the magnetic gripper according to FIG. 5, wherein the magnetic gripper is displaced towards the workpiece until the magnetic portion comes into contact with the workpiece,

FIG. 7 is a schematic side view of the magnetic gripper according to FIG. 5, wherein the magnetic gripper is displaced further towards the workpiece until the magnetic portion is displaced by the workpiece from the contact position to the gripping position,

FIG. 8 is a schematic side view of the magnetic gripper according to FIG. 5, wherein the magnetic gripper is displaced together with the workpiece,

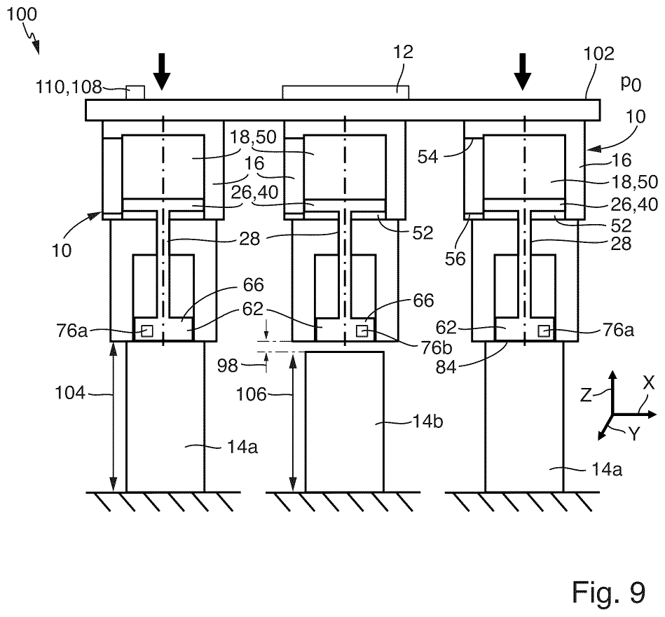

FIG. 9 is a schematic side view of a system according to the invention with three magnetic grippers according to the invention, wherein two workpieces with a first height and one workpiece with a second height are to be gripped,

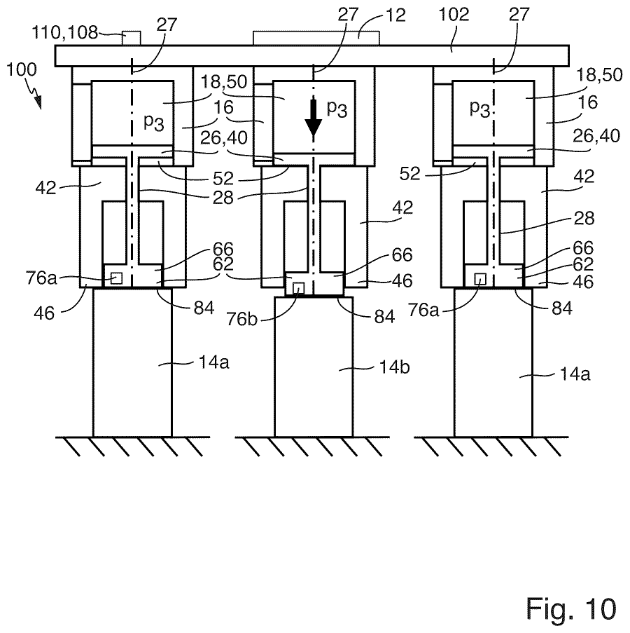

FIG. 10 is a schematic side view of a system according to FIG. 9, wherein two magnetic grippers each have a stripping portion on two workpieces and wherein a magnetic gripper with a protruding magnetic portion lies on the third workpiece,

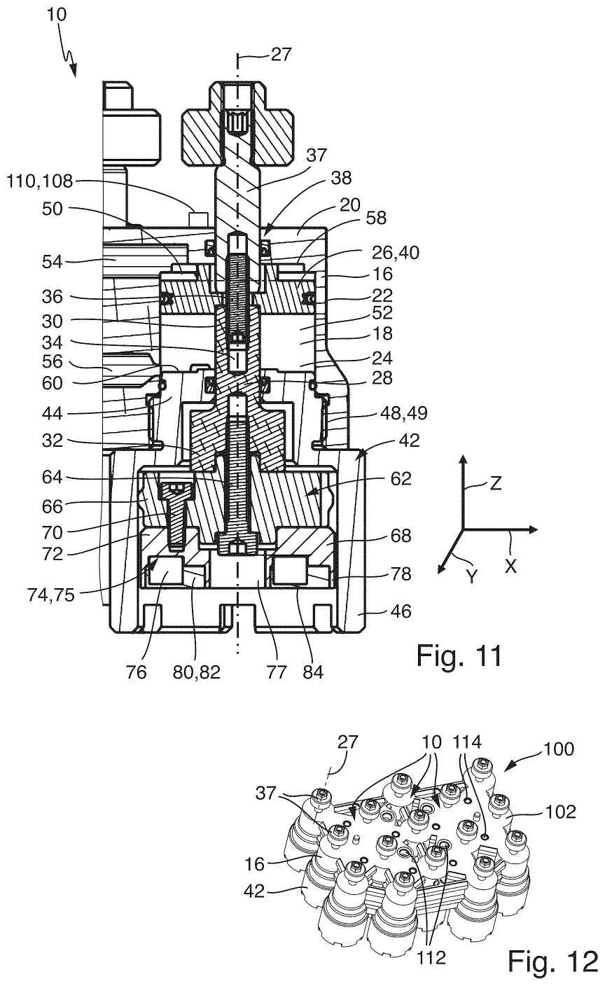

FIG. 11 is a schematic partial section of a magnetic gripper according to the invention,

FIG. 12 is a perspective view of a system according to the invention as a magnetic gripper cluster with 15 magnetic grippers according to the invention,

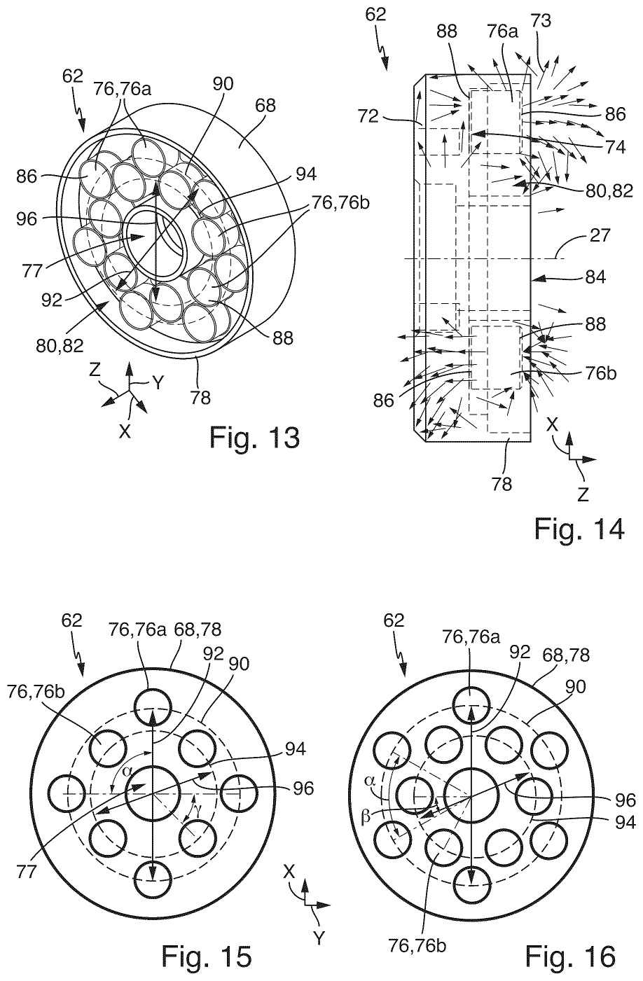

FIG. 13 is a perspective view of a magnetic portion and a stripping portion of a magnetic gripper according to the invention,

FIG. 14 is a sectional view of the magnetic gripper according to FIG. 13,

FIG. 15 is a schematic front view of a magnetic gripper according to the invention with eight holding magnets,

FIG. 16 is a schematic front view of a magnetic gripper according to the invention with 12 holding magnets,

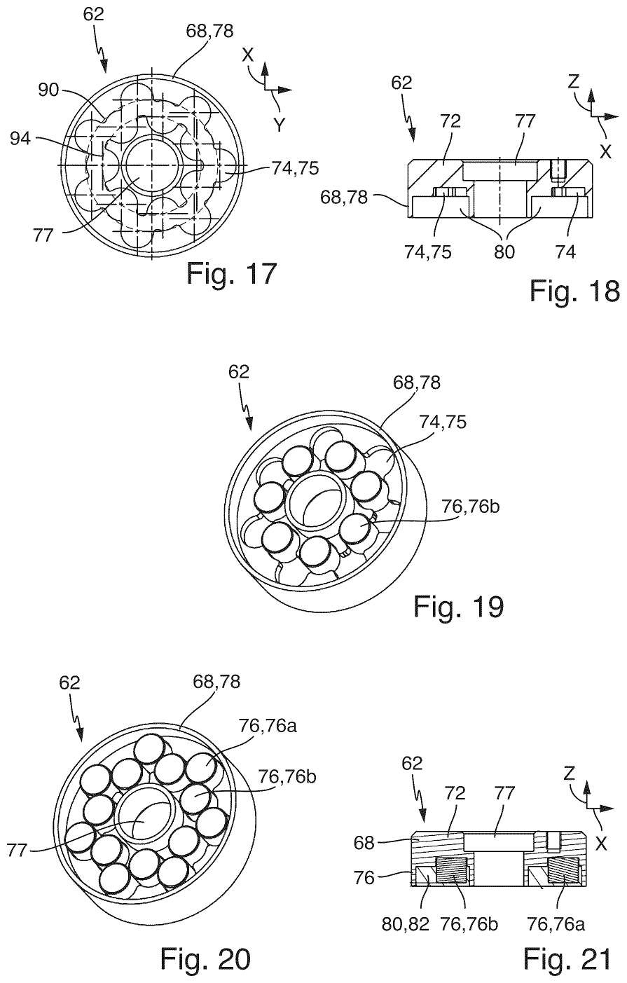

FIG. 17 is a schematic front view of a magnet holder,

FIG. 18 is a schematic sectional view of the magnet holder according to FIG. 17,

FIG. 19 is a perspective view of the magnet holder according to FIG. 17 with 7 of 14 mounted holding magnets,

FIG. 20 is a perspective view of the magnet holder according to FIG. 17 with 14 mounted holding magnets,

FIG. 21 is a schematic side view of the magnet holder according to FIG. 17 with an empty space filled with epoxy resin,

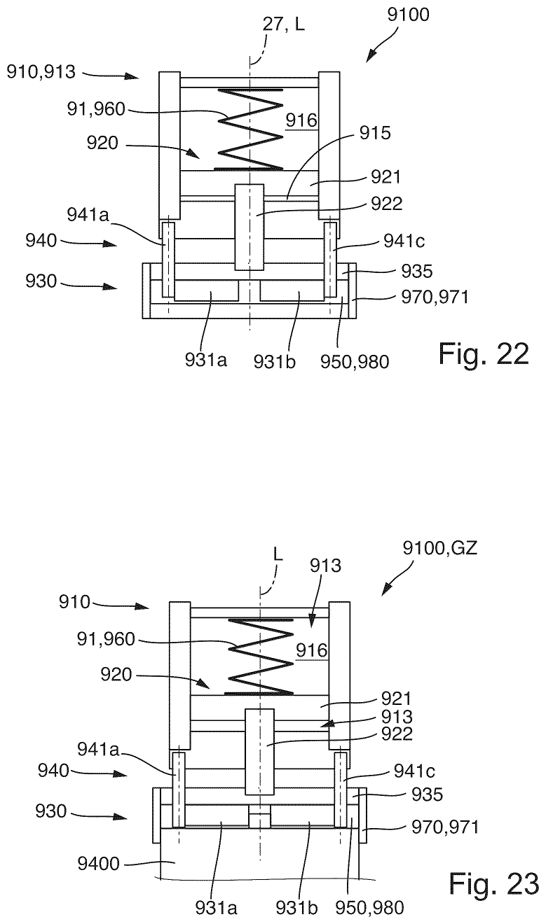

FIG. 22 to FIG. 25 show a magnetic gripper according to the invention;

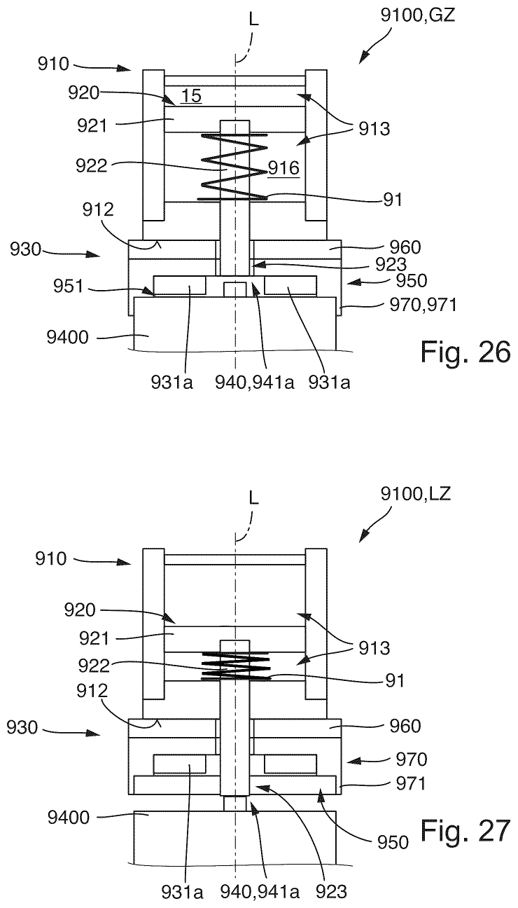

FIG. 26 and FIG. 27 show another magnetic gripper according to the invention;

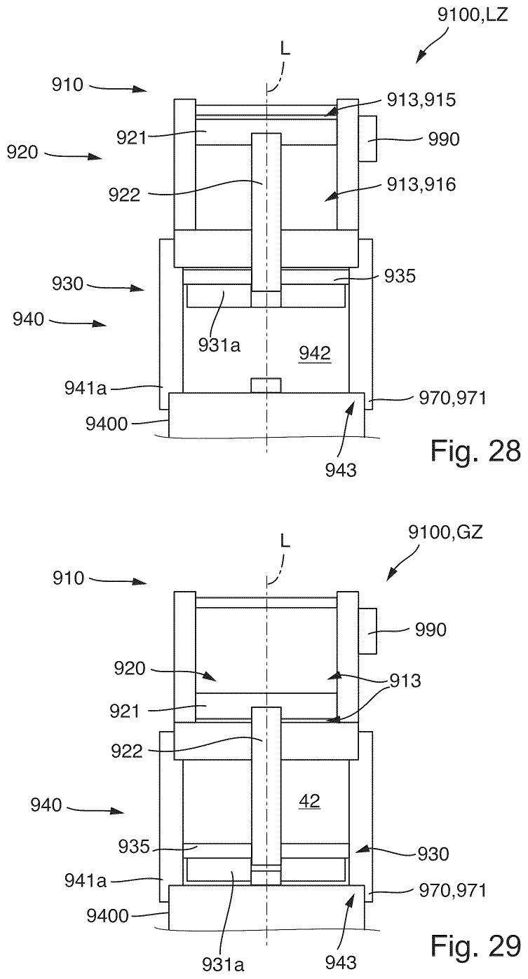

FIG. 28 and FIG. 29 show another magnetic gripper according to the invention;

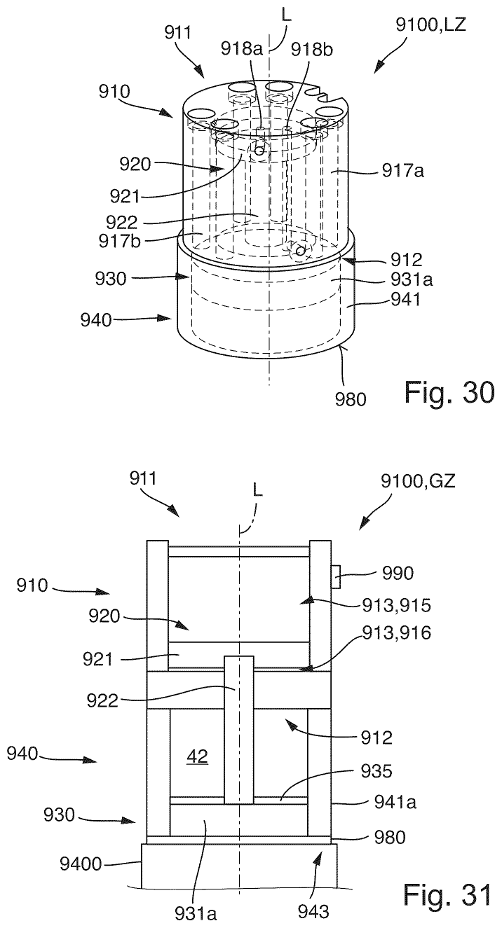

FIG. 30 and FIG. 31 show another magnetic gripper according to the invention;

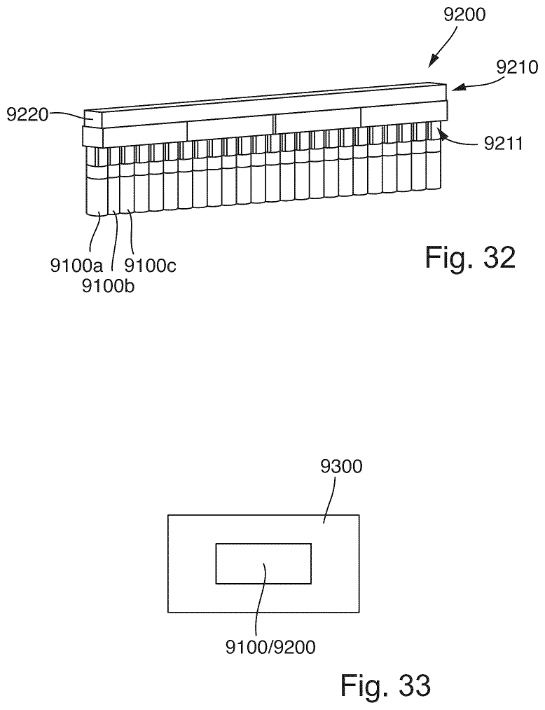

FIG. 32 shows a system according to the invention; and

FIG. 33 shows a handling device according to the invention.

FIG. 11 shows a partial section of a magnetic gripper 10 according to the invention. FIGS. 1 to 8 also show the magnetic gripper 10 according to the invention according to FIG. 11 in an abstracted representation. The magnetic gripper 10 is used for arrangement on a handling device 12 shown in FIG. 9 and for gripping an at least partially magnetizable and/or ferromagnetic workpiece 14. The magnetic gripper 10 has a pot-shaped gripper base portion 16 with a cylindrical interior space 18. The interior space 18 is delimited by a cylinder base 20 and a sleeve-shaped cylinder jacket 22. The interior space 18 of the gripper base portion 16 is accessible from the cylinder base 20 through a cylinder opening 24.

The magnetic gripper 10 further comprises a piston portion 26 with a piston rod 28 arranged along a longitudinal axis 27, wherein the piston rod 28 has a first rod end 30 facing the cylinder base 20 and a second rod end 32 opposite the first rod end 30. The piston rod 28 provides a guide receptacle 34 at its first rod end 30 for receiving a guide element 36. Furthermore, a bottom recess 38 is provided in the cylinder base 20 for receiving the guide element 36. In addition, the piston portion 26 has a piston 40, wherein the piston 40 is arranged at the first rod end 30. The piston 40 is arranged in the interior space 18 of the gripper base portion 16 so as to be displaceable along the longitudinal axis 27. A positioning plunger 37 is also provided on the guide element 36, which plunger is designed as an extension of the piston rod 28 and serves to query the position of the piston 40.

The magnetic gripper 10 has a substantially cylindrical stripping portion 42 with a stripping head 44 facing the gripper base portion 16 and a stripper 46 opposite the stripping head 44. The stripping head 44 comprises on its outer side an outer first threaded portion 48 which is screwed into an inner second threaded portion 49 arranged at the gripper base portion 16. In the screwed-in state, the stripping head 44 opposite the cylinder base 20 closes the interior space 18 of the gripper base portion 16. Accordingly, the gripper base portion 16 and the stripping head 44 with the piston 40 form a cylinder-piston unit.

The piston 40 delimits a first pressure chamber 50 with the cylinder base 20 and the cylinder jacket 22. The piston 40 further delimits a second pressure chamber 52 with the stripping head 44 and the interior space 18. Accordingly, the piston portion 26 is guided in a displaceable manner in the cylinder base 20 and, via the piston 40, on the cylinder jacket 22. The first pressure chamber 50 is fluidically connected to a first pressure medium distribution channel 54. The second pressure chamber 52 is fluidically connected to a second pressure medium distribution channel 56. The piston 40 is displaceable along the longitudinal axis 27 between an upper first cylinder end 58 assigned to the cylinder base 20 and a lower second cylinder end 60 assigned to the stripping head 44, wherein the first pressure chamber 50 can be subjected to a first operating pressure p₁ by means of the first pressure medium distribution channel 54 and/or the second pressure chamber 52 can be subjected to a second operating pressure p₂ by means of the second pressure medium distribution channel 56. The distance between the first cylinder end 58 and the second cylinder end 60 corresponds to the maximum stroke of the piston 40.

The magnetic gripper 10 further comprises a magnetic portion 62, wherein the magnetic portion 62 is arranged at the second rod end 32 of the piston rod 28, in particular by means of at least one first fastening means 64 extending along the longitudinal axis 27, such as a screw. The magnetic portion 62 is guided on the inside of the stripping portion 42 so as to be displaceable along the longitudinal axis 27. The magnetic portion 62 has an insulating element 66 and a magnet holder 68, wherein the first fastening means 64 fastens the insulating element 66 to the piston rod 28 and a second fastening means 70 extending parallel to the longitudinal axis 27 fastens the magnet holder 68 to the insulating element 66.

The magnet holder 68 has a holder base 72 facing the insulating element 66, wherein magnet receptacles 74 are provided in the holder base 72 for receiving holding magnets 76 (not shown). The holding magnets 76 form a magnetic field 73, which is used for the magnetic gripping of the workpieces 14. The magnet receptacle 74 can be inserted in the holder base 72 in the form of a groove. Alternatively, the magnet receptacle 74, as shown in FIGS. 17 and 19, can be designed as a plurality of circular recesses 75, which are arranged next to one another along a circumference with a radial offset from one another. Due to the overlap of the circular recesses 75, the magnet receptacle 74 is formed, which is continuous along the circumference of the circle and in which the holding magnets 76 can be securely positioned. This ensures that the holding magnets 76 generate a defined magnetic field 73.

The magnet holder 68, in particular the holder base 72, has an opening 77, whereby the magnetic portion 62 can be detached from the piston rod 28 via the fastening screw 64 even when the magnet holder 68 is in the mounted state on the insulating element 66.

According to FIGS. 17 to 21, a holding leg 78 protruding from the holder base 72 is also arranged at the holder base 72. The holding leg 78 is circular and radially surrounds the holding magnets 76. Due to the insulating element 66, the holder base 72 and the holding leg 78, it can be ensured that the magnetic field 73 generated by the holding magnets 76 is axially oriented and preferably acts in the direction of the workpiece 14 to be gripped. Furthermore, the magnetic field 73 can be radially secured by the holding leg 78 so that the magnetic fields 73 in adjacent magnetic grippers 10 do not influence one another.

The cavity 80 formed by the holder base 72, the holding magnets 76 and the holding leg 78 can preferably be filled with a filler 82, in particular epoxy resin, which does not influence the magnetic field. The effective surface 84 of the magnetic portion 62 facing the workpiece is then turned or milled flat, so that a defined underside of the magnetic portion 62 is provided. Due to the magnet receptacle 74, a defined distance or air gap can accordingly be provided between the magnetic gripper 62 and the workpiece 14.

For the targeted axial orientation of the magnetic field, it is advantageous if the magnetic portion 62 according to FIGS. 13 to 21 has at least one first holding magnet 76a with a magnetic north pole 86 facing the workpiece 14 and at least one second holding magnet 76b with a magnetic south pole 88 facing the workpiece. Accordingly, the first holding magnet 76a has a magnetic south pole 88 facing the holder base 72 and the second holding magnet 76b has a magnetic north pole 86 facing the holder base 72. In the magnetic portions 62 of FIGS. 13, 17 to 21, seven first holding magnets 76a and seven second holding magnets 76b are provided. In the magnetic portions 62 of FIG. 15, four first holding magnets 76a and four second holding magnets 76b are provided. In the magnetic portions 62 of FIG. 16, six first holding magnets 76a and six second holding magnets 76b are provided.

The first holding magnets 76a, in particular their centers, are arranged along a first circular line 90 with a first diameter 92 arranged around the longitudinal axis 27. The first holding magnets 76a are evenly spaced along the circular line 90. Two adjacent first holding magnets 76a, in particular their centers, enclose a first angle α with the longitudinal axis 27, wherein the first angle α corresponds to the formula 360°/n_{number of first holding magnets}.

Accordingly, for example, two adjacent first holding magnets 76a have a first angle α of 60° when six first holding magnets 76a are provided.

The second holding magnets 76b, in particular their centers, are arranged along a second circular line 94 with a second diameter 96 arranged around the longitudinal axis 27. The second holding magnets 76b are evenly spaced along the circular line 94. Two adjacent second holding magnets 76b, in particular their centers, enclose a second angle β with the longitudinal axis 27, wherein the angle β corresponds to the formula 360°/n_{number of second holding magnets}. Accordingly, two adjacent second holding magnets 76b have a second angle β of 60° when six second holding magnets 76b are provided.

The holding magnets 76 are arranged in alternating fashion, so that a first holding magnet 76a and a second holding magnet 76b alternate along the circular lines 90, 94. With a total of twelve holding magnets 76, two adjacent holding magnets 76, i.e., a first holding magnet 76a and a second holding magnet 76b, have a third angle γ of 30°.

Furthermore, the holding magnets 76 are arranged such that the first diameter 92 is greater than the second diameter 96. The first diameter 92 and the second diameter 96 have a ratio between 0.2:1 and 5:1, in particular between 0.5:1 and 3:1, preferably between 1:1 and 2:1, and preferably between 1.2:1 and 1.5:1. Consequently, the first holding magnets 76a have an offset radially outward and the second holding magnets 76b have an offset radially inward. Due to the offset arrangement of the holding magnets 76, an axially oriented magnetic field 73 is created, so that a safe gripping of workpieces 14 is possible even with an air gap between the magnetic portion 62 and the workpiece 14.

FIGS. 1 to 4 and FIGS. 5 to 8 show two different methods for gripping workpieces 14 by means of a magnetic gripper 10 according to the invention. The magnetic gripper 10 is arranged at a handling device 12 (not shown) and can be moved by it along the axes X, Y and Z.

In FIG. 1, the magnetic gripper 10 is in a starting position above the workpiece 14 to be gripped, where the arrow shows that the entire magnetic gripper 10 has been moved. The distance 98 between the magnetic gripper 10, in particular the stripping portion 46, and the workpiece 14 is approximately 2 mm, where the distance 98 in the illustration shows, for better illustration, a distance 98 greater than 2 mm in relation to the magnetic gripper 10 and the workpiece 14. The distance 98 allows for the magnetic gripper 10 to approach the workpiece fast without an unwanted collision occurring. The magnetic portion 62 is in an upper release position in which no relevant magnetic action emanates from the magnetic portion 62 on the workpiece 14. The release position of the magnetic portion 62 corresponds to the position of the piston 40 in the region of the upper first cylinder end 58.

In FIG. 2, the magnetic portion 62 is in a lower contact position, wherein the magnetic portion 62 contacts the workpiece 14 and thus a magnetic connection exists between the magnetic portion 62 and the workpiece 14. The contact position of the magnetic portion 62 corresponds to the position of the piston 40 in the region of the lower second cylinder end 60. To displace the magnetic portion 62 from the release position to the contact position, i.e., in the Z direction, the first pressure chamber 50 is subjected to a third operating pressure p₃ by means of the first pressure medium distribution channel 54. The stripping portion 42, in particular the stripping head 44, forms the end stop of the piston 40 opposite the Z direction.

In FIG. 3, the magnetic portion 62 is displaced counter to the Z direction along the longitudinal axis 27 in such a way that the magnetic portion 62 is flush with the stripper 46. In this position, the magnetic portion 62 is in a gripping position arranged between the release position and the contact position. To displace the magnetic portion 62 from the contact position to the gripping position, the second pressure chamber 52 is subjected to a fourth operating pressure p₄. The workpiece 14 is pulled against the stripping portion 42 and/or a presser (not shown) in order to ensure that the workpiece 14 is evenly contacted. The magnet holder 68 or the stripping portion 42 can further provide a sleeve-shaped guide portion (not shown) for more safely receiving the workpieces 14 during gripping. In this case, the guide portion has an inner cross section which corresponds to the outer cross section of the workpiece 14 to be gripped.

Subsequently, the workpiece 14 can be handled according to FIG. 4, wherein the magnetic portion 62 remains in the gripping position and the entire magnetic gripper 10 is displaced by the handling device 12.

The first operating pressure p₁ preferably serves to displace the magnetic portion 62 from the release position to the contact position. The second operating pressure p₂ preferably serves to displace the magnetic portion 62 from the contact position and/or gripping position to the release position. The third operating pressure p₃ serves as a cushion and/or suspension when approaching the workpiece when the magnetic portion 62 is in the contact position. The fourth operating pressure p₄ serves to displace the magnetic portion 62 from the contact position to the gripping position when the magnetic portion 62 contacts a workpiece 14 in the contact position and attracts it to the stripping portion 42.

Preferably, the first operating pressure p₁ corresponds to the second operating pressure p₂. Furthermore, it is conceivable that the third operating pressure p₃ is less than the first operating pressure p₁ and/or the second operating pressure p₂. Furthermore, it is conceivable that the fourth operating pressure p₄ is less than the first operating pressure p₁ and/or the second operating pressure p₂. The first operating pressure p₁ and/or the second operating pressure p₂ is preferably 6 bar. The third operating pressure p₃ is preferably determined from the ratio between the maximum permissible force Fₚₑᵣₘ which is applied from the outside to the gripping surface Aₚᵢₛₜₒₙ Of the workpiece 14 to be gripped:

$$p 3 = \frac{F p e r m}{A piston}$$

Furthermore, the fourth operating pressure p₄ is greater than the ratio between Aₚᵢₛₜₒₙ of the weight force F_{wght Wkp} of the workpiece 14 and the gripping surface and/or is smaller than the ratio between the magnetic force and the gripping surface:

$$\frac{F weight force of workpiece}{A piston} < p 4 < \frac{F magnet}{A piston}$$

In FIG. 5, the magnetic gripper 10 is in a starting position above the workpiece 14 to be gripped. Before the workpiece 14 is approached by the magnetic gripper 10, the magnetic portion 62 is displaced into the contact position.

The first pressure chamber 50 is thus subjected to a third operating pressure p₃ such that the magnetic portion 62 can be moved against the workpiece 14 in a spring-loaded manner, in particular with a damping. This allows the workpieces 14 to be gripped particularly gently.

As soon as the third operating pressure p₃ has formed in the first pressure chamber 50, the magnetic gripper 10 with the magnetic portion 62 protruding from the stripping portion 42 opposite the Z-axis can be displaced to the workpiece 14. In the contact position, the magnetic portion 62 according to FIG. 6 contacts the workpiece 14, wherein the axially directed magnetic field 73 has an attractive effect on the workpiece 14. The stripping portion 42 preferably has a distance 98 from the workpiece 14.

According to FIG. 7, the magnetic portion 62 is displaced counter to the Z direction along the longitudinal axis 27 such that the magnetic portion 62 is flush with the stripper 46. In this position, the magnetic portion 62 is in the gripping position. The workpiece 14 is attracted against the stripping portion 42 and/or a presser (not shown).

Subsequently, the workpiece 14 can be handled according to FIG. 8, wherein the magnetic portion 62 remains in the gripping position and the entire magnetic gripper 10 is displaced by the handling device 12.

As a further method, a combination of the method shown in FIGS. 1 to 4 and the method shown in FIGS. 5 to 8 is conceivable. First, the magnetic gripper 10 with the protruding magnetic portion 62 is displaced towards the workpiece 14 until the magnetic portion 62 contacts the workpiece 14 according to FIG. 6 and the stripping portion 42 has a distance 98 from the workpiece 14. Subsequently, the workpiece is pulled towards the stripping portion 42 as shown in FIG. 3, with the magnetic gripper 10 remaining in its position. Then the workpiece 14 is displaced according to FIG. 4 by displacing the entire magnetic gripper 10.

According to FIGS. 9 and 10, a plurality of magnetic grippers 10 can be combined in a system 100 according to the invention as a magnetic gripper cluster. The system 100 serves for the simultaneous gripping of a plurality of workpieces 14, wherein one magnetic gripper can be provided for each workpiece 14 to be gripped. In this case, the system 100 has a receiving device 102 for receiving three magnetic grippers 10, each of which is intended to grip a workpiece 14. The workpieces 14 comprise two first workpieces 14a and a second workpiece 14b, wherein the first workpieces 14a have a first height 104 and the second workpiece 14b has a second height 106. For example, the first height 104 is 2 mm greater than the second height 106.

FIG. 9 shows the first step when using the system 100 according to the invention. However, this also represents the currently existing art. When the workpieces 14 are approached by a system 100 with a plurality of magnetic grippers 10, the left and right magnetic grippers 10 come into contact with the associated first workpieces 14a, since these have a first height 104. Neither the system 100 nor the center magnetic gripper 10 can be moved further downward to grip the second workpiece 14b with the lower second height 106. In the prior art, the middle second workpiece 14b would therefore not be gripped.

According to FIG. 10, the system 100 according to the invention with the magnetic gripper 10 according to the invention can grip the middle second workpiece 14b despite the height offset. For this purpose, the magnetic portion 62 is displaced counter to the Z direction beyond the stripping portion 42 into the contact position. In the contact position, the magnetic portion 62 contacts the second workpiece 14b and can attract it to the stripping portion 42. Accordingly, all workpieces 14 are gripped, with all magnetic portions 62 arranged in the gripping position.

FIG. 12 shows a system 100 designed as a magnetic gripper cluster with 15 magnetic grippers 10, wherein the magnetic grippers 10 are arranged in a matrix of 5×3. In order to achieve a particularly high packing density, the columns and rows of the matrix are arranged offset from one another. Accordingly, adjacent lines of 3 with magnetic grippers 10 are each offset from one another by a radius of a magnetic gripper 10. It is conceivable for the systems 100 to be designed in a modular manner, so that a large number of systems 100 are combined in order to handle more than 15 workpieces 14 simultaneously.

Furthermore, a control and/or regulating device 108 with a processor and a memory can be provided on the system 100 and/or for each magnetic gripper 10, wherein the control and/or regulating device 108 serves to control and/or regulate the pressure medium supply, in particular the pressurization of the pressure chambers 50, 52. Furthermore, at least one sensor 110 for detecting the position, the pressure and/or the volume flow can be provided on the magnetic gripper 10. The control and/or regulating device 108 can initiate the pressure medium supply depending on the sensor signals of the at least one sensor 110. Furthermore, the control and/or regulating device 108 can detect the functionality of a magnetic gripper 10.

In a system 100 with magnetic grippers 10 arranged in a matrix, it is advantageous if one sensor 110 is provided per cluster of, for example, 15 magnetic grippers 10, and/or per row and/or per column. In the event of a failure of a cluster, a column and/or a row of magnetic grippers 10, maintenance can then be directed accordingly.

It is further conceivable that in a system 100 with a plurality of magnetic grippers 10, a pressure medium inlet is provided for each magnetic gripper 10, each cluster, each column and/or each row. If a first pressure medium inlet 112 for the first pressure chamber 50 and a second pressure medium inlet 114 for the second pressure chamber 52 are provided for a cluster, then in each case a first pressure medium distribution channel 54 leads from the first pressure medium inlet 112 to the first pressure chamber 50 of a magnetic gripper 10, and in each case a second pressure medium distribution channel 56 leads from the second pressure medium inlet 114 to the second pressure chamber 52 of a magnetic gripper 10.

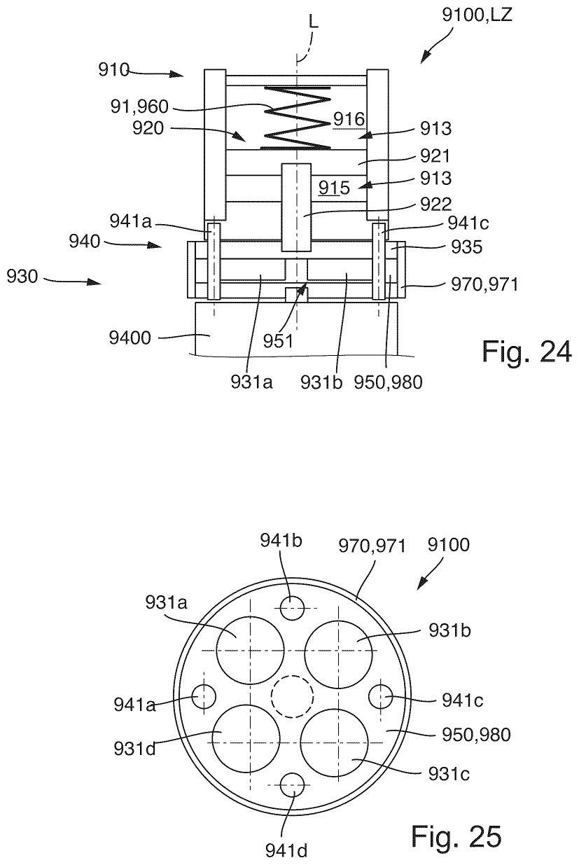

FIG. 22 to FIG. 24 show a first embodiment of a magnetic gripper 9100 according to the invention in a schematic sectional view. In FIG. 23, the magnetic gripper 9100 is in a gripping state GZ, i.e., the magnetic gripper 9100 has gripped a workpiece 9400. In FIG. 24, the magnetic gripper 9100 is in a release state LZ, i.e., the magnetic gripper 9100 has stripped or released a workpiece 9400. FIG. 4 shows the embodiment shown in FIGS. 22 to 24 in a bottom view. The magnetic gripper 9100 of this embodiment has a gripper base portion 910 with an interior space 913. In the interior space 913, a piston rod 922 and a piston 921 arranged at the piston rod 922 are arranged. The piston rod 922 can be displaced by means of the piston 921 along a longitudinal axis L of the piston rod 922. At least a part of the piston rod 922 can be guided, while supported, out of the gripper base portion 910 via a recess in the gripper base portion 910. The piston 921 divides the interior space 913 into a first active chamber 915 and a second active chamber 916. The first active chamber 915 can be pressurized with a pressure medium for displacing the piston 921 and thus the piston rod 922. In the second active chamber 916, a spring element 91 is arranged for displacing the piston 921 and thus the piston rod 922. In a pressureless state of the first active chamber 915, the spring element 91 can hold the piston 921 in a forward position, in particular in a piston gripping position. This has the advantage that when the magnetic gripper 9100 is placed on the workpiece 9400, e.g., a battery cell, the spring element 91 has a compensating effect in the longitudinal direction L of the piston rod 922 (see FIG. 23). The spring element 91 thus also serves as a damping element 960 for a damping gripping of the workpiece 9400. In addition, the workpiece 9400, e.g., a battery cell, can be handled as desired by means of the magnetic gripper 9100 even in the pressureless state of the first active chamber 915, without the workpiece 9400 being released. The spring element 91 thus also acts as a safety element. Alternatively, the gripper base portion 910 with the piston portion 920 can also be designed to be double-acting.

Furthermore, the magnetic gripper 9100 shown in FIGS. 22 to 25 comprises a magnetic portion 930 with, for example, four holding magnets 931a, 931b, 931c and 931d for magnetically gripping the workpiece 9400. The magnetic portion 930 has a receiving body 935, in particular a plate-shaped receiving body 935, for receiving the four holding magnets 931a, 931b, 931c and 931d on a side of the receiving body 935 facing the workpiece 9400. The receiving body 935 is arranged outside the gripper base portion 910 at one piston rod end of the piston rod 922 that extends out of the gripper base portion 910. In addition, a centering edge 971 is arranged at the receiving body 935 as a centering element 970 for a centered gripping of the workpiece 9400.

The magnetic gripper 9100 further comprises a stripping portion 940 arranged at the gripper base portion 910 with a plurality of pin-shaped strippers 941a, 941b, 941c and 941d arranged rigidly on the gripper base portion 910 for releasing a magnetic gripping connection between the magnetic portion 930 and the workpiece 9400.

Advantageously, the plurality of strippers 941a, 941b, 941c and 941d is arranged radially offset from one another about the longitudinal axis L of the piston rod 922. By pressurizing the first active chamber 915 with a pressure medium, the piston rod 922 can be moved along the longitudinal axis L of the piston rod 922 and thus the magnetic portion 930 arranged at the piston rod 922 with the holding magnets 931a, 931b, 931c, 931d can be moved away from the workpiece 9400, wherein the plurality of strippers 941a, 941b, 941c and 941d prevent the workpiece 9400 from moving along with the magnetic portion 930, or the holding magnets 931a, 931b, 931c and 931d, moving away from the workpiece 9400. Thus, the workpiece 9400 is stripped or released from the magnetic gripper 9100.

Furthermore, the magnetic portion 930 of the magnetic gripper 9100 shown in FIGS. 22 to 25 comprises, on a side of the receiving body 935 facing the workpiece 9400, a friction element 950 for frictionally contacting the workpiece 9400 in the gripping state GZ of the magnetic gripper 9100, wherein the holding magnets 931a, 931b, 931c and 931d are embedded in the friction element 950. The friction element 950 further comprises in particular a recess 951, so that a predefined distance is formed between the at least one holding magnet 931a, 931b, 931c and 931d in the magnetic gripping connection with the workpiece 9400. The friction element 950 can thus function simultaneously as a separating element 980, in particular a non-magnetic and/or non-magnetizable separating element, and as a friction element 950. In the bottom view shown in FIG. 25, it can be seen that both the plurality of holding magnets 931a, 931b, 931c, 931d of the magnetic portion 930 and the plurality of strippers 941a, 941b, 941c, 941d are each arranged radially distributed around the longitudinal axis L of the piston rod 922.

FIG. 26 and FIG. 27 show a further embodiment of a magnetic gripper 9100 according to the invention in a schematic sectional view. In FIG. 926, the magnetic gripper 9100 is in a gripping state GZ, i.e., the magnetic gripper 9100 has gripped a workpiece 9400. In FIG. 27, the magnetic gripper 9100 is in a release state LZ, i.e., the magnetic gripper 9100 has stripped or released a workpiece 9400. The magnetic gripper 9100 of this embodiment has a gripper base portion 910 with an interior space 913. In the interior space 913, a piston rod 922 and a piston 921 arranged at the piston rod 922 are arranged. The piston rod 922 can be displaced by means of the piston 921 along a longitudinal axis L of the piston rod 922. In this embodiment, the piston rod 922 itself represents a stripping portion 940 with a stripper 941a of the magnetic gripper 9100 for releasing a magnetic gripping connection between a magnetic portion 930 and the workpiece 9400. The piston 921 divides the interior space 913 into a first active chamber 915 facing away from the workpiece 9400 and a second active chamber 916. The first active chamber 915 can be pressurized with a pressure medium for displacing the piston 921 and thus the piston rod 922. In the second active chamber 916, a spring element 91 is arranged for displacing the piston 921 and thus the piston rod 922. In a pressureless state of the first active chamber 915, the spring element 91 can hold the piston 921 in a rear position, in particular in a piston gripping position. Thus, in the event of a pressure drop in the first active chamber 915, the piston 921 and thus the piston rod 922 can be held in the rear position and an unwanted release of the workpiece 9400 can be prevented by means of the piston rod 922. The spring element 1 thus also acts as a safety element. Alternatively, the gripper base portion 910 with the piston portion 920 can also be designed to be double-acting.

Furthermore, the magnetic gripper 9100 shown in FIGS. 26 and 27 comprises a magnetic portion 930 with at least one holding magnet 931a and a damping element 960 for a damping gripping of the workpiece 9400. The holding magnet 931a is arranged via the damping element 960, which is arranged at least partially on a gripping side 912, facing the gripped workpiece 9400, of the gripper base portion 910, for the damping gripping of the workpiece 9400 to the gripper base section 910. The damping element 960 is, for example, plate-shaped and can additionally have an opening for guiding the piston rod 922 of the piston portion 920. In FIG. 26 and FIG. 927, for example, the damping gripping of the workpiece 9400 is carried out (only) by the damping element 960 arranged at the gripping side 912, facing the gripped workpiece 9400, of the gripper base portion 910. In other words, by way of example, when the magnetic gripper 9100 is placed on the workpiece 9400 for gripping the workpiece 9400, for example a battery cell, the spring element 91 does not have a compensating effect in the longitudinal direction L of the piston rod 922, as described for example for FIGS. 22 to 25. However, it is also conceivable that the piston portion 920 is designed or configured in such a way that the spring element 91 arranged in the second active chamber 916 also has a compensating effect in the longitudinal direction L of the piston rod 922, for example by a corresponding length of the piston rod 922. Thus, for example the piston portion 920 has a (first) damping element for the damping gripping of the workpiece 9400 and the magnetic portion 930 has a (second) damping element for the damping gripping of the workpiece 9400. In addition, a friction element 950 of the magnetic portion 930, for example in the form of a glass-fiber-reinforced plastics material, is arranged between the damping element 960 and the holding magnet 931a of the magnetic portion 930 for frictional contact with the workpiece 9400. In this way, the holding magnet 931a can be made weaker while at the same time the holding of the workpiece 9400 is ensured. The friction element 950 can also have an opening for guiding the piston rod 922. In addition, the friction element 950 can act as a centering element 970 by having a centering edge 971 for a centered receiving of the workpiece 9400. In this embodiment, the friction element 950 can also additionally have a recess 951, so that a predefined distance is formed between the at least one holding magnet 931a in the magnetic gripping connection with the workpiece 9400. In other words, the holding magnet 931a does not directly contact the workpiece 9400 in the gripping state GZ of the magnetic gripper 9100. By applying pressure to the first active chamber 915, a piston rod end 923 of the piston rod 922 can be moved as a stripper 941a along the longitudinal axis L of the piston rod 922 towards the gripped workpiece 9400 (cf. FIG. 26 and FIG. 27), so that the piston rod end 923 of the piston rod 922 actively moves or (actively) pushes the workpiece 9400 away from the magnetic portion 930 arranged at the gripper base portion 910, or the holding magnet 931a of the magnetic portion 9300, thus releasing the magnetic gripping connection between the magnetic portion 930 and the workpiece 9400.

FIG. 28 and FIG. 29 show a further embodiment of a magnetic gripper 9100 according to the invention in a schematic sectional view. In FIG. 28, the magnetic gripper 9100 is in a release state LZ, i.e., the magnetic gripper 9100 has stripped or released a workpiece 9400. In FIG. 29, the magnetic gripper 9100 is in a gripping state GZ, i.e., the magnetic gripper 9100 has gripped a workpiece 9400. The magnetic gripper 9100 of this embodiment has a gripper base portion 910 with an interior space 913. In the interior space 913, a piston rod 922 and a piston 921 arranged at the piston rod 922 are arranged. The piston rod 922 can be displaced by means of the piston 921 along a longitudinal axis L of the piston rod 922. The actuator piston 921 divides the interior space 913 into a first active chamber 915 and a second active chamber 916. The first active chamber 915 and the second active chamber 916 can each be pressurized with a pressure medium for displacing the piston 921 and thus the piston rod 922. In other words, the gripper base portion 910 with the piston portion 920 is designed to be double-acting. The piston rod 922 is guided out of the gripper base portion 910 via a recess in the gripper base portion 910.

Furthermore, the magnetic gripper 9100 shown in FIGS. 28 and 29 comprises a magnetic portion 930 with at least one holding magnet 931a for magnetically gripping the workpiece 9400. The magnetic portion 930 further comprises a receiving body 935, in particular a plate-shaped receiving body 935, for receiving the holding magnet 931a on a side of the receiving body 935 facing the workpiece 9400. The receiving body 935 is arranged outside the gripper base portion 910 at one piston rod end 923 of the piston rod 922 which extends out of the gripper base portion 910.

Furthermore, the magnetic gripper 9100 shown in FIGS. 28 and 29 comprises a stripping portion 940 arranged at the gripper base portion 910 with a stripper 941a rigidly arranged at the gripper base portion 910 for releasing a magnetic gripping connection between the magnetic portion 930 and the workpiece 9400. The stripper 941a of the stripping portion 940 arranged at the gripper base portion 910 is hollow and forms a stripper cavity 942 for guiding the magnetic portion 930 arranged at the piston rod 922 in the stripper cavity 942 along the longitudinal axis L of the piston rod 922, wherein the stripper 941a has a stop for stopping the workpiece 9400 on a stripper end 943, facing the gripped workpiece 9400, of the stripper 941a. The magnetic gripper 9100 is preferably designed such that the holding magnet 931a does not or cannot contact the workpiece 9400 in a gripping state of the magnetic gripper 9100. In addition, the stripper 941a has a centering edge 971 at the stripper end 943 for a centered gripping of the workpiece 9400, so that the stripper 941a simultaneously functions as a centering element 970. Furthermore, a state sensor 990, for example a magnetic switch, is arranged at an outer side of the gripper base portion 910 for detecting the gripping state GZ of the magnetic gripper 9100, in which the magnetic portion 930 is in the magnetic gripping connection with the workpiece 9400 (see FIG. 29), and for detecting the release state LZ of the magnetic gripper 9100, in which the magnetic gripping connection between the magnetic portion 930 and the workpiece 9400 is released (see FIG. 28). The magnetic switch detects the axial position of the piston 921 for detecting the gripping state GZ or the release state LZ of the magnetic gripper 9100. The other embodiments according to the invention can also have such a state sensor 990.

FIG. 30 and FIG. 31 show a further embodiment of a magnetic gripper 9100 according to the invention in a perspective view and a schematic sectional view, respectively. In FIG. 30, the magnetic gripper 9100 is in a release state LZ, i.e., the magnetic gripper 9100 has stripped or released a workpiece 9400. In FIG. 31, the magnetic gripper 9100 is in a gripping state GZ, i.e., the magnetic gripper 9100 has gripped a workpiece 9400. As already described for the embodiment shown in FIG. 28 and FIG. 29, here as well the gripper base portion 910 with the piston portion 920 is designed to be double-acting, for example. Alternatively, the gripper base portion 910 with the piston portion 920 can also be designed to be single-acting. The piston rod 922 is guided out of the gripper base portion 910 via a recess on a gripping side 912, facing the gripped workpiece 9400, of the gripper base portion 910. In addition, the magnetic gripper 9100 comprises a stripping portion 940 arranged at the gripper base portion 910 with a stripper 941a arranged at the gripper base portion 910 for releasing a magnetic gripping connection between the magnetic portion 930 and the workpiece 9400. The stripping portion 940 or the stripper 941a is arranged at the gripper base portion 910 by means of a plurality of bottom-side screw connections 917a, 917b. The screw connections 917a, 917b extend parallel to the longitudinal axis L of the piston rod 922 in a wall of the gripper base portion 910 and in the stripper 941a, wherein threads are formed in the stripper 941a. The wall of the gripper base portion 910 connects the bottom side 911 of the gripper base portion 910 with the gripping side 912 of the gripper base portion 910. Furthermore, the stripper 941a of the stripping portion 940 arranged at the gripper base portion 910 is hollow shaped, for example hollow cylindrical, and forms a stripper cavity 942. Thus, the magnetic portion 930 arranged at the piston rod 922 can be guided in the stripper cavity 942 along the longitudinal axis L of the piston rod 922. The hollow cylindrical stripper 941a can in particular have the same or substantially the same diameter as the workpiece 9400, for example a battery cell. Advantageously, the gripper base portion 10 is also cylindrical, so that the magnetic gripper 9100 can be particularly compact.

Furthermore, the magnetic gripper 9100 shown in FIG. 30 and FIG. 31 comprises a non-magnetic and/or non-magnetizable separating plate 980 on a stripper end 943, facing the gripped workpiece 9400, of the stripper 941a for easy removal of the holding magnet 931a from the workpiece 9400. The separating plate 980 is for example an aluminum sheet, the aluminum sheet having for example a thickness of 0.5 mm. In addition, it is conceivable that a friction element 950, in particular a friction ring, is arranged at the separating plate 980 for the frictional contacting of the workpiece 9400. In particular, in the gripping state GZ of the magnetic gripper 9100, the holding magnet 931a moves to within a few millimeters, in particular less than 0.5 mm, of the separating plate 980. Advantageously, the air gap is kept as small as possible. The gripper base portion 910 with the interior space 913, the piston portion 920 with the piston 921 and the piston rod 922, the magnetic portion 930 and the stripping portion 940 of the magnetic gripper 910 are in particular designed or matched with one another in such a way that the holding magnet 931a of the magnetic portion 930 has or maintains a predefined distance from the gripped workpiece or the separating plate 980 in the gripping state GZ of the magnetic gripper 9100. This makes it particularly easy to prevent damage to the separating element 980. In other words, the magnetic gripper 9100 is designed such that the holding magnet 931a does not or cannot contact the separating plate 980 in a gripping state of the magnetic gripper 9100. In addition, the gripper base portion 910 has a first pressure medium inlet 918a and a second pressure medium inlet 918b on the bottom side 911 of the gripper base portion 910, each for supplying the piston 921 arranged in the interior space 913 with a pressure medium for displacing the piston 921 along the longitudinal axis L of the piston rod 922. Such pressure medium inlets 918a, 918b can also have the other embodiments according to the invention. The pressure medium inlets 918a and 918b are designed such that the bottom side 911 of the gripper base portion 910 is flat or substantially flat. The pressure medium inlets 918a and 918b can form direct connections for arrangement at correspondingly designed pressure medium interfaces of a pressure medium distribution channel 9220 of a magnetic gripper receiving device 9210 (see e.g., FIG. 32). By pressurizing the second active chamber 916 with a pressure medium, the piston rod 922 can be moved along the longitudinal axis L of the piston rod 922 and thus the magnetic portion 930 arranged at the piston rod 922 with the holding magnets 931a can be moved away from the workpiece 9400, wherein the stripper 941a together with the separating agent 980 prevents the workpiece 9400 from moving along with the magnetic portion 930 or holding magnet 931a, moving away from the workpiece 9400. Thus, the workpiece 9400 is stripped or released from the magnetic gripper 9100.

FIG. 32 discloses a perspective view of a system 9200 according to the invention. The system includes an elongated magnetic gripper receiving device 9210 with a receiving portion 9211. A plurality of magnetic grippers 9100a, 9100b, 9100c is received in the receiving portion 9211. The plurality of magnetic grippers 9100a, 9100b, 9100c is preferably magnetic grippers 9100 according to the invention, as already described for example in the previous figures. The plurality of magnetic grippers 9100a, 9100b, 9100c is received in a row next to one another in the receiving portion 9211. Furthermore, the magnetic gripper receiving device 9210 can have at least one pressure medium distribution channel 9220 (not visible) extending at least along the longitudinal direction of the magnetic gripper receiving device 9210, or a plurality of pressure medium distribution channels for fluidically supplying each of the plurality of magnetic grippers 9100a, 9100b, 9100c with a pressure medium for displacing a corresponding piston 921 of the magnetic grippers 9100a, 9100b, 9100c. Thus, magnetic grippers 9100a, 9100b, 9100c with bottom-side pressure medium inlets 918a, 918b (see e.g., FIG. 31) can each be supplied with the pressure medium without the use of hoses, via the pressure medium distribution channel 9220, or the pressure medium distribution channels. The magnetic gripper receiving device 9210 itself can have at least one pressure medium supply or a plurality of pressure medium supplies for supplying the pressure medium distribution channel 9220 with one pressure medium or a plurality of pressure media.

FIG. 33 shows a schematic representation of a handling device 9300 with at least one magnetic gripper 9100 designed according to the invention or with a system 9200 designed according to the invention.

1-18. (canceled)

19. A magnetic gripper for a handling device for gripping an at least partially magnetizable and/or magnetic workpiece, the magnetic gripper comprising:
a gripper base portion with an interior space,
a piston portion with a piston rod extending along a longitudinal axis and with a piston arranged at the piston rod and in the interior space,
a magnetic portion with at least one holding magnet for gripping the workpiece, wherein the magnetic portion is arranged at the piston portion, wherein the magnetic portion is displaceable with the piston portion along the longitudinal axis between an upper release position and a lower contact position,
a stripping portion with at least one stripper arranged at the piston rod and/or at the gripper base portion for releasing a gripping connection between the magnetic portion and the workpiece when the magnetic portion is displaced in the direction of the release position,
wherein the gripper base portion and/or the piston portion are designed such that the magnetic portion, in the contact position, protrudes along the longitudinal axis relative to the stripping portion, wherein the magnetic portion has a magnet holder for receiving the holding magnets.

20. The magnetic gripper according to claim 19, wherein the stripping portion has a plurality of strippers, wherein in particular the plurality of strippers is arranged radially offset from one another about the longitudinal axis of the piston rod.

21. The magnetic gripper according to claim 19, wherein the magnetic portion has an insulating element arranged between the magnet holder and the piston portion.

22. The magnetic gripper according to claim 21, wherein the magnet holder has a holding leg radially surrounding the at least one holding magnet for orienting a magnetic field generated by the holding magnets and/or for radially shielding the at least one holding magnet, wherein the magnet holder, in particular the holding leg, is designed to be magnetic and/or metallic.

23. The magnetic gripper according to claim 19, wherein the magnetic gripper has at least one state sensor for detecting a gripping state in which the magnetic portion is in the magnetic gripping connection with the workpiece, and/or a release state in which the magnetic gripping connection between the magnetic portion and the workpiece is released, and/or a stripping state of the magnetic gripper and/or a position sensor for detecting the position of the magnetic portion and/or the piston portion.

24. A system for a handling device, the system comprising:
a magnetic gripper receiving device with a receiving portion for receiving magnetic grippers,
a plurality of magnetic grippers, wherein each of the plurality of magnetic grippers is designed according to the magnetic gripper of claim 19, and wherein the plurality of magnetic grippers are received in the receiving portion of the magnetic gripper receiving device.

25. The system according to claim 24, characterized in that the magnetic gripper receiving device has at least one pressure medium distribution channel for fluidically supplying each of the plurality of magnetic grippers with a pressure medium for displacing a corresponding piston of the magnetic grippers.

26. The system according to claim 24, wherein the system is designed such that, for gripping the workpieces, a first magnetic portion is displaced into the contact position and, at the same time, a second magnetic portion is displaced into a gripping position.

27. A handling device, in particular robot and/or manipulator, with at least one magnetic gripper according to claim 19.

28. A method for gripping at least partially magnetizable and/or magnetic workpieces with a height offset from one another,
with magnetic grippers with magnetic portions that can be displaced along a longitudinal axis between an upper release position and a lower contact position and stripping portions for releasing the magnetic connection between the magnetic portions and the workpieces, or
with the magnetic gripper according to claim 19,
comprising the following steps:
a) moving the magnetic grippers to a starting position above the workpieces, wherein first stripping portions contact first workpieces,
b) applying the magnetic portions to the workpieces by moving the magnetic portions,
wherein first magnetic portions above first workpieces are displaced into a gripping position arranged between the contact position and the release position, and
wherein second magnetic portions above second workpieces are displaced into the contact position,
c) lifting the second workpieces by displacing the second magnetic portions into the gripping position, wherein second workpieces contact the second stripping portions,
d) handling the workpieces, and
e) releasing the workpieces from the magnetic grippers by displacing the magnetic portions into the release position, wherein the stripping portions release the magnetic connection between the magnetic portions and the workpieces.

29. A method for gripping at least partially magnetizable and/or magnetic workpieces with a height offset from one another,
with magnetic grippers with magnetic portions that can be displaced along a longitudinal axis between an upper release position and a lower contact position and stripping portions for releasing the magnetic connection between the magnetic portions and the workpieces, or
with the system according to claim 24,
comprising the following steps:
a) displacing the magnetic portions into the contact position,
b) moving the magnetic grippers to a starting position above the workpieces,
wherein first stripping portions and first magnetic portions contact first workpieces, and
wherein second magnetic portions contact second workpieces,
c) lifting the second workpieces by displacing the second magnetic portions into a gripping position arranged between the contact position and the release position, wherein the second workpieces contact second stripping portions,
d) handling the workpieces, and
e) releasing the workpieces from the magnetic grippers by displacing the magnetic portions into the release position, wherein the stripping portions release the magnetic connection between the magnetic portions and the workpieces.
